(19) United States
(12) Patent Application Publication
(10) Pub. No.: US 2011/0212278 A1
(43) Pub. Date: Sep. 1, 2011

(54) INK JET RECORDING MEDIUM AND METHOD OF MANUFACTURING THE SAME

(75) Inventors: Tsutomu WATANABE, Kanagawa (JP); Hiroshi KAWAKAMI, Kanagawa (JP); Ryoichi NAKANO, Kanagawa (JP)

(73) Assignee: FUJIFILM CORPORATION, Tokyo (JP)

(21) Appl. No.: 13/034,716

(22) Filed: Feb. 25, 2011

(30) Foreign Application Priority Data
Feb. 26, 2010 (JP) 2010-043294

(51) Int. Cl. B41M 5/00; B05D 1/36; B05D 3/02

(52) U.S. Cl. 428/32.18; 427/419.7; 427/397.7

(57) ABSTRACT

An inkjet recording medium includes a water-impermeable substrate, and a first ink-receiving layer containing kaolin and a second ink-receiving layer containing fumed silica which are provided on the water-impermeable substrate in this order from the water-impermeable substrate side, wherein at least the first ink-receiving layer further contains a boron compound, and the content ratio (% by mass) of boron in the total solid content of the first ink-receiving layer is higher than the content ratio (% by mass) of boron in the total solid content of the second ink-receiving layer.

### CROSS-REFERENCE TO RELATED APPLICATION

This Application claims priority under 35 USC 119 from Japanese Patent Application No. 2010-043294, filed on Feb. 26, 2010, the disclosure of which is incorporated by reference herein.

### BACKGROUND OF THE INVENTION

1Field of Invention

The present invention relates to an ink jet recording medium and a method of manufacturing the same.

2. Description of the Related Art

With recent rapid advances in the information technology industry, various information-processing systems have been developed, and recording methods and apparatuses which are suitable for the information-processing systems have been developed and put into practical use. Among these recording methods, inkjet recording methods have been widely used in homes as well as in offices because the inkjet recording methods have the advantages that they enable recording on various recording materials on which an image or the like is to be recorded, hardware (i.e., apparatuses) for the inkjet recording is relatively inexpensive and space-saving, little noise is made, and so on.

Recently, owing to the realization of high-resolution inkjet printers, the development of hardware (i.e., apparatuses) for the inkjet recording, and the development of various media for inkjet recording, “photograph-like” high-quality recorded images can be obtained.

In general, media for inkjet recording are required to have characteristics including: (1) quick-drying property (i.e., high absorption speed of ink), (2) an adequate and uniform dot diameter of ink dots (free from bleeding), (3) excellent granularity, (4) high dot sphericity, (5) high color density, (6) high color saturation (no dullness), (7) excellent light resistance, gas resistance and water resistance of an image portion, (8) high whiteness of recording sheets, (9) high storage stability (free from yellowing and bleeding of an image during long-term storage), (10) resistance to deformation; that is, high dimensional stability (low curling) and (11) excellent conveyance properties through hardware. Furthermore, when the medium used for inkjet recording is glossy photo paper that is used for obtaining a “photograph-like” high-quality recorded image, the medium for inkjet recording is required to have glossiness, surface smoothness, a texture like developing paper similar to that for silver halide photography and the like, in addition to the above characteristics.

In relation to the above, various media for inkjet recording have been disclosed.

For example, as an inkjet recording medium having excellent ink absorbency, printing density, water resistance, or the like, an inkjet recording sheet is known that includes at least two coating layers provided on a substrate, in which an uppermost coating layer contains, as main components, a silica-based pigment, an organic polymer adhesive agent and a cationic polymer dye-fixing agent, and a coating layer directly provided on the substrate contains, as main components, a pigment other than a silica-based pigment and an organic polymer adhesive agent, (see, for example, Japanese Patent Application Laid-open (JP-A) No. 9-86032).

As an inkjet recording sheet having reduced monochrome bleeding and mixed-color bleeding resistance and excellent water resistance, an inkjet recording sheet is known that includes a substrate which mainly contains cellulose fibers and, on the substrate, an ink-receiving layer which contains a pigment mainly containing silica and calcined clay, a binder, and a dye-fixing agent, in which the pigment mainly contains synthetic amorphous silica and calcined clay, and the weight ratio of the synthetic amorphous silica to the calcined clay is in a range of from 80/20 to 40/60 (for example, JP-A No. 2002-362009).

Further, as an inkjet recording medium which is excellent in ink absorbency as well as color developability and color reproducibility and is suitable for proofreading of printing, an inkjet recording medium is known in which two ink receiving layers each contain a pigment and binding agent, and the two ink receiving layers are continuously laminated on a surface of a substrate. The pigment in a lower ink receiving layer contains kaolin and amorphous synthetic silica as main components and the pigment in an upper ink receiving layer contains metal oxide fine particles produced by a gas-phase process, as the main components (for example, JP-A No. 2005-103827).

Further, as an inkjet recording medium which has no roughness, is excellent in inkjet recording suitability and ink absorbency, and is capable of providing glossiness and the image clarity of photographic paper for silver halide photography, an inkjet recording medium is known that includes an under layer, an ink-receiving layer and a gloss development layer laminated on a substrate in this order, wherein each of the under layer, the ink-receiving layer and the gloss development layer contains a pigment and an adhesive as main components, a pigment in the under layer contains calcined kaolin as a main component, a porous pigment in the ink-receiving layer contains a pigment as a main component which has from two to five times more oil absorption than calcined kaolin, a pigment in the gloss developing layer contains inorganic superfine particles having an average particle diameter of 500 nm or less as a main component, and the gloss developing layer is formed by a cast treatment method (for example, JP-A No. 2005-280149).

Furthermore, as an inkjet recording sheet for an inkjet printer which has the glossiness of a photographic printing paper, has an excellent ink absorption rate and an excellent ink absorption amount, and does not produce film defects caused by cracks during drying in a process of producing an ink-receiving layer, an inkjet recording sheet is known that includes at least two ink-receiving layers on a substrate, in which a film-surface pH of a lower ink-receiving layer is from 6.5 to 8.5, and an ink-receiving layer provided directly on top of the lower ink-receiving layer contains a binder resin, a cationic resin and silica having an average particle diameter of 1 μm or less measured by dynamic light scattering and has a film-surface pH of from 2 to 5.5 (for example, JP-A No. 2004-330729).

Furthermore, as an inkjet recording medium which is excellent in print density and glossiness, an inkjet recording medium is known that includes at least two layers of a porous ink-receiving layer on a substrate, in which an average pore diameter of a porous ink-receiving layer closer to the substrate (a lower layer) (hereinafter, referred to as d1) is larger than an average pore diameter of a porous ink-receiving layer more distant from the substrate (an upper layer) (hereinafter, referred to as d2), where d1 represents 15 to 40 nm, and d2 represents 8 nm to 25 nm (see, for example, JP-A No. 2005-138295). JP-A No. 2005-138295 discloses the lower layer containing wet-process silica and the upper layer containing fumed silica.

### SUMMARY OF THE INVENTION

In recent years, there has been demand for an inkjet recording medium which suppresses occurence of fingerprint marks when a surface of the inkjet recording medium is pressed with a finger (for example, a semi-glossy inkjet recording medium).

In the inkjet recording medium described in JP-A Nos. 9-86032, 2002-362009, 2005-103827, 2005-280149, 2004-330729 and 2005-138295, there are cases where both suppression of the occurence of fingerprint marks and improvement of surface conditions cannot be satisfied.

The present invention has been made in view of the above circumstances and provides an ink jet recording medium and a method of manufacturing the same.

According to a first aspect of the invention, there is provided an inkjet recording medium including: a water-impermeable substrate, and a first ink-receiving layer containing kaolin and a second ink-receiving layer containing fumed silica which are provided on the water-impermeable substrate in this order from a water-impermeable substrate side, wherein at least the first ink-receiving layer further contains a boron compound, and a content ratio (% by mass) of boron in a total solid content of the first ink-receiving layer is higher than a content ratio (% by mass) of boron in a total solid content of the second ink-receiving layer.

According to a second aspect of the invention, there is provided a method of manufacturing an inkjet recording medium, the method including: forming an ink-receiving layer by simultaneously multilayer-coating, onto a water-impermeable substrate, at least a first coating liquid containing kaolin and a second coating liquid containing fumed silica in this order from a water-impermeable substrate side, wherein at least the first coating liquid further contains a boron compound, and a content ratio (% by mass) of boron in a total solid content of the first coating liquid is higher than a content ratio (% by mass) of boron in a total solid content of the second coating liquid.

### DETAILED DESCRIPTION OF THE INVENTION

Inkjet Recording Medium

The inkjet recording medium of the invention includes a water-impermeable substrate, and a first ink-receiving layer containing kaolin and a second ink-receiving layer containing fumed silica which are provided on the water-impermeable substrate in this order from the water-impermeable substrate side, in which at least the first ink-receiving layer contains a boron compound and the content ratio (% by mass) of boron in the total solid content of the first ink-receiving layer is higher than the content ratio (% by mass) of boron in the total solid content of the second ink-receiving layer. The expression “content ratio of X in the total solid content of Y″ represents a ratio of the amount of X contained in Y relative to the total amount of solid contained in Y, unless specifically indicated otherwise.

The inkjet recording medium of the invention includes at least a water-impermeable substrate, and a first ink-receiving layer containing kaolin and a second ink-receiving layer containing fumed silica which are provided on the water-impermeable substrate in this order from the water-impermeable substrate side, in which the content ratio (% by mass) of boron in the total solid content has the above configuration, whereby the surface condition of the inkjet recording medium is improved.

In the present specification, “surface condition is improved” or “excellent in surface condition” represents a state in which surface defects such as a streak are suppressed on the surface of the ink-receiving layer of the inkjet recording medium.

The reason for the improvement of the surface condition is not clear, but it may be because a coating liquid for forming an ink-receiving layer which contains kaolin (a first coating liquid) has less tendency to be gelatinized, compared to a coating liquid for the ink-receiving layer which contains fumed silica (a second coating liquid).

In the present specification, “total solid content” of the ink-receiving layer (or the coating liquid) represents the total contents excluding water and a solvent from the ink-receiving layer (or the coating liquid).

Further, the inkjet recording medium of the invention includes at least a water-impermeable substrate, and a first ink-receiving layer containing kaolin and a second ink-receiving layer containing fumed silica which are provided on the water-impermeable substrate in this order from the water-impermeable substrate side, whereby occurrence of a fingerprint mark is suppressed when the surface is pressed with a finger.

Therefore, the inkjet recording medium of the invention can be preferably used as a semi-gloss inkjet recording medium.

“Semi-gloss” represents a state in which a glossiness at an angle of 60° of a surface measured by a DIGITAL VARIABLE ANGLE GLOSS METER (trade name, manufactured by Suga Test Instrument Co., Ltd.) is from 5% to 30%.

In the present specification, “glossiness” simply represents a glossiness at an angle of 60° (referred to as “60° glossiness”).

In the inkjet recording medium of the invention, 60° glossiness of a surface of the inkjet recording medium at a side at which the ink-receiving layer is provided is preferably from 8% to 28%, and more preferably from 10% to 25%.

In the prior art, the semi-gloss inkjet recording medium is produced using a special substrate having a surface on which roughness treatment has been performed surface, hence there are not many choices of materials that can be used as a substrate. That is to say, the material of the substrate material had to be changed, in a case of producing a high gloss inkjet recording medium and in a case of a semi-gloss inkjet recording medium.

In the invention, when a semi-gloss inkjet recording medium is produced, a water-impermeable substrate which is the same substrate generally used in a high gloss inkjet recording medium, and the composition of a coating liquid for forming an ink-receiving layer is changed, whereby the semi-gloss inkjet recording medium can be produced. Therefore the choice of materials used as a substrate is broad.

Further, a water-impermeable substrate is used in the inkjet recording medium of the invention, and therefore deformation such as curling while image recording is suppressed.

In the inkjet recording medium of the invention, it is preferred that 60° glossiness of a surface of the inkjet recording medium at a side at which the ink-receiving layer is provided (hereinafter, referred to as “glossiness B”) is at least 30% lower than 60° glossiness of a surface of the water-impermeable substrate at a side at which the ink-receiving layer is provided (hereinafter, referred to as “glossiness A”).

Therefore, when a water-impermeable substrate where the ink-receiving layer is formed for producing a high gloss inkjet recording medium is used, the inkjet recording medium suppressing occurrence of fingerprint mark (for example, semi-gloss inkjet recording medium) can be obtained.

Next, a method of measuring 60° glossiness of the water-impermeable substrate in the inkjet recording medium of the invention is described.

First, the inkjet recording medium of the invention is immersed for 1 minute in sodium hypochlorite solution heated to 80° C., and then the ink-receiving layer is removed with a sponge under flowing water, and dried.

After drying, 60° glossiness of the surface of the water-impermeable substrate at a side at which the ink-receiving layer is removed is measured by DIGITAL VARIABLE ANGLE GLOSS METER (trade name, manufactured by Suga Test Instrument Co., Ltd.), whereby 60° glossiness (glossiness A) of the water-impermeable substrate in the inkjet recording medium of the invention can be measured.

In the inkjet recording medium of the invention, at least the first ink-receiving layer further contains a boron compound, and the content ratio (% by mass) of boron in the total solid content of the first ink-receiving layer is higher than the content ratio (% by mass) of boron in the total solid content of the second ink-receiving layer.

In other words, when the content ratio (% by mass) of boron in the total solid content of the first ink-receiving layer is defined as content ratio 1 and the content ratio (% by mass) of boron in the total solid content of the second ink-receiving layer is defined as content ratio 2, the ratio (content ratio 2/content ratio 1) is less than 1.00.

For example, the ratio (content ratio 2/content ratio 1) can be determined by ICP (inductively coupled plasma) emission analysis of an extracted component of the ink-receiving layer.

The ratio (content ratio 2/content ratio 1) is preferably from 0.10 to 0.90, more preferably from 0.30 to 0.90, and particularly preferably from 0.50 to 0.90, from the viewpoints of strength of the second ink-receiving layer and improvement of surface condition of the inkjet recording medium.

Further, the content ratio 1 is preferably from 0.30% by mass to 2.00% by mass, more preferably from 0.30% by mass to 1.50% by mass, and particularly preferably from 0.30% by mass to 1.20% by mass, from the viewpoints of further improving surface condition of the inkjet recording medium.

From the viewpoints of further improving surface condition of the inkjet recording medium, the inkjet recording medium of the invention preferably has a configuration in which the ratio (content ratio 2/content ratio 1) is within the preferable range thereof described above, and, simultaneously, the content ratio 1 is within the preferable range thereof described above.

The content ratio 2 is not specifically limited, as long as the ratio (content ratio 2/content ratio 1) is less than 1.00, but from the viewpoints of further improving strength of the second ink-receiving layer, the content ratio 2 is preferably from 0.25% by mass to 1.80% by mass, and more preferably from 0.25% by mass to 1.00% by mass.

Ink-Receiving Layer

The inkjet recording medium of the invention include at least two ink-receiving layers including the first ink-receiving layer (close to the water-impermeable substrate) and the second ink-receiving layer (distant from the water-impermeable substrate).

Each of the first ink-receiving layer and the second ink-receiving layer may have a single layer structure or two or more layers structure.

In the present specification, all ink-receiving layers including the first ink-receiving layer and the second ink-receiving layer in the inkjet recording medium of the invention are collectively referred to as “all ink-receiving layers,” and each ink-receiving layer is generically simply referred to as “ink-receiving layer,” unless explicitly indicated otherwise.

Further, in the present specification, the first ink-receiving layer is referred to as “layer close to the water-impermeable substrate” or “lower layer” and the second ink-receiving layer is referred to as “layer distant from the water-impermeable substrate” or ^{“}upper layer”.

Each of the components contained in the ink-receiving layer is described.

Kaolin

The first ink-receiving layer in the invention contains at least one kind of kaolin. The kaolin is used as a pigment in the first ink-receiving layer, whereby glossiness of the all ink-receiving layers is suppressed and occurence of a fingerprint mark is suppressed.

The kaolin is not specifically limited, and for example, in addition to natural kaolin clay (hereinafter, simply also referred to as “kaolin clay”), processed kaolin clay such as calcined kaolin and delaminated kaolin can be used.

The calcined kaolin represents amorphous aluminum silicate anhydride in which natural kaolin clay has been heated at high temperature in a furnace and water of crystallization has been removed. Examples of the calcined kaolin include ALPHATEX, OPCITEX (trade names, manufactured by Imerys Minerals Japan K.K.), KAOCAL (trade made, manufactured by SHIRAISHI CALCIUM KAISHA, LTD.), ANSILEX 93 (trade name, manufactured by Engelhard Corporation), and GLOMAXLL (trade name, manufactured by TAKEHARA KAGAKU KOGYO CO., LTD.).

The delaminated kaolinite is formed by applying mechanical force to natural kaolin clay (kaolinite) to carry out interlayer detachment pulverization, and has a flat plate shape. The kaolinite represents a silicate having 1:1 layer of two octahedrals. Although the 1:1 layer ideally represents a chemical composition of Al₂Si₂O₅.(OH)₄, a few Fe³⁺ is included in place of Al as octahedral cations in many cases. Therefore, kaolinite generally represents a plate shape, but when physical force is applied externally, detachment occurs between layers and flatter kaolinite is obtained. Since this pulverization method is generally referred to as delamination pulverization for the purpose of layer detachment, the kaolinite obtained by this operation is referred to as delaminated kaolin, delamination clay, delaminated clay, or the like. In the delaminated kaolin of the invention, engineered delaminated kaolin having a particle diameter in the specific range is also included.

Further, the aspect ratio of the kaolin is generally about from 15 to 20. Regarding particularly referred to as engineered delaminated kaolin when the ratio having fine and uniform particle diameter the aspect ratio of the engineered delaminated kaoin is larger than 50.

Examples of the delaminated kaolin include ASTRA PLATE (trade name, manufactured by Imerys Minerals Japan K.K.), KAOWHITE S, KAOWHITE, and KAOWHITE C (trade names, manufactured by SHIRAISHI CALCIUM KAISHA, LTD.), POLYPLATE P, POLYPLATE P01, and POLYPLATE HMT (trade names, manufactured by J.M. Huber Corporation), Nu clay (manufactured by Engelhard Corporation), and KAOLUX-HS (trade name, manufactured by SHIRAISHI CALCIUM KAISHA, LTD.), ASTRA-PLUS(trade name, manufactured by Imerys Minerals Japan K.K.), engineered delamination kaolin such as CONTOUR 1500 (tracde name), CONTOUR 2070 (tracde name), CONTOUR XTREME (tracde name), CAPIM DG (tracde name), CAPIM NP (tracde name) and CAPIM CC (tracde name).

Examples of the kaolin clay include ASTRA-SHEEN, ASTRA-GLOSS, ASTRA-COTE, BETA-BRITE, ASTRA-GLAZE, PREMIER LX, PREMIER, and KCS (manufactured by Imerys Minerals Japan K.K.; trade names), KAOGLOSS 90, KAOBRITE 90, KAOGLOSS, KAOBRITE, and KAOFINE (trade names, manufactured by SHIRAISHI CALCIUM KAISHA, LTD.), Union clay RC-1 (trade name, manufactured by TAKEHARA KAGAKU KOGYO CO., LTD.), HUBER35, HUBER35B, HUBER80, HUBER80B, HUBER90, HUBER90B, HUBERHG90, HUBER TEK2001, POLYGLOSS90, and LITHOSPERSE 7005CS (trade names, manufactured by J.M. Huber corporation).

Among them, from the viewpoints effectively suppressing occurrence of a fingerprint mark and achieving absorbency, the kaolin of the invention is preferably calcined kaolin.

The average particle diameter of the kaolin contained in the first ink-receiving layer is not specifically limited, but from the viewpoints of effectively suppressing occurrence of a fingerprint mark, 0.3 μm to 15 μm is preferable and 1 μm to 10 μm is more preferable.

As a pigment component, other pigments other than the kaolin may be used in combination with the kaolin in the first ink-receiving layer.

Examples of the other pigments include silica fine particles such as fumed silica or wet-process silica described below, colloidal silica, titanium dioxide, barium sulfate, calcium silicate, zeolite, halloysite, mica, talc, calcium carbonate, magnesium carbonate, calcium sulfate, boehmite, and pseudo-boehmite.

The mass ratio of the kaolin to the total pigment content in the first ink-receiving layer is preferably 20% by mass to 100% by mass, and more preferably 50% by mass to 100% by mass, from the viewpoints of further effectively suppressing occurrence of a fingerprint mark.

The mass ratio of the kaolin to the total solid content in the first ink-receiving layer is 20% by mass to 90% by mass, more preferably 30% by mass to 90% by mass, even more preferably 40% by mass to 90% by mass, and particularly preferably 50% by mass to 90% by mass, from the viewpoints of further effectively suppressing occurrence of a fingerprint mark.

Fumed Silica

The second ink-receiving layer of the invention contains at least one kind of fumed silica.

The fumed silica is used as a pigment in the second ink-receiving layer, whereby printing density and ink absorbency are improved.

In general, the silica fine particles are roughly classified into wet process silica particles and dry process silica (fumed silica) particles according to the production method thereof.

In the wet process, a method of producing hydrous silica by forming active silica by acid decomposition of a silicate, polymerizing the active silica to a certain degree, and allowing the resultant polymerized product to aggregate and precipitate, is widely used. The silica fine particles obtained by the wet process are also referred to as “wet-process silica” in the present invention.

In the vapor-phase process, a method of producing anhydrous silica by high-temperature vapor-phase hydrolysis of a silicon halide (flame hydrolysis) or a method in which silica sand and coke are subjected to heat reduction and evaporation by arc in an electronic furnace and the resultant product is oxidized by air (arc process), are widely used. The “fumed silica” as used herein refers to anhydrous silica fine particles obtained by the vapor-phase processes.

The fumed silica differs from the hydrous silica in density of silanol groups on the surface thereof, the presence or absence of pores, and the like, and exhibits different properties from those of the hydrous silica. The fumed silica is suitable for forming three-dimensional structures having high porosity, though the reason is not clear. It may be because, while the hydrous silica fine particles tend to closely aggregate (i.e., form aggregates) owing to high silanol densities of from 5 groups/nm² to 8 groups/nm² on the fine particle surface, the fumed silica particles form loose aggregates (i.e., flocculates) owing to low silanol densities of from 2 groups/nm² to 3 groups/nm² on the fine particle surface, which results in formation of a highly-porous structure.

As the fumed silica contained in the second ink-receiving layer, fumed silica having silanol densities on the surface of from 2groups /nm² to 3groups/nm² is particularly preferred.

The average particle diameter of the fumed silica contained in the second ink-receiving layer is not specifically limited, but the average particle diameter is preferably 10 nm or less, from the viewpoints of further improving printing density and ink absorbency.

Further, the specific surface area of the fumed silica contained in the second ink-receiving layer measured by BET method is preferably 200 m²/g or more, more preferably 250 m²/g or more and particularly preferably 380 m²/g or more. When the specific surface area of the fumed silica contained in the second ink-receiving layer is 200 m²/g or more, high transparency of the ink-receiving layer is achieved and high printing density can be maintained.

The BET method of the invention is one of the methods of measuring the surface area of powder employing a gas-phase absorption method, and the total surface area per 1 g of a specimen, namely the specific surface area, is obtained from the absorption isotherm. Nitrogen gas is widely used as an adsorption gas, and a method of measuring the absorbed amount from a change in the pressure or volume of the absorption gas is most commonly used. The most well-known expression that expresses an isotherm of multi-molecular absorption is equation of Brunauer, Emmett and Teller method (referred to as BET equation), and is widely used for determining the surface area. The gas absorption amount is obtained based on BET equation, and the adsorption amount is multiplied by the surface area occupied by one absorption molecule in order to determine the surface area.

The second ink-receiving layer may include the fumed silica and other pigments other than the fumed silica, as the pigment component.

Examples of the additional pigment include silica fine particles other than fumed silica (such as wet-process silica), colloidal silica, titanium dioxide, barium sulfate, calcium silicate, zeolite, the above-described kaolin, halloysite, mica, talc, calcium carbonate, magnesium carbonate, calcium sulfate, boehmite, and pseudo-boehmite.

The mass ratio of the fumed silica with respect to the total pigment contents in the second ink-receiving layer is 60% by mass to 100% by mass, and more preferably 80% by mass to 100% by mass, from the viewpoints of further improving printing density and ink absorbency.

The mass ratio of the fumed silica with respect to the total solid contents in the second ink-receiving layer is preferably 40% by mass to 90% by mass, and more preferably 50% by mass to 80% by mass, from the viewpoints of further improving printing density and ink absorbency.

Binder

It is preferable that each of the first ink-receiving layer and the second ink-receiving layer contains at least one binder.

When each of the first ink-receiving layer and the second ink-receiving layer contains at least one binder, the pigment is more preferably dispersed, whereby coating film strength can be further improved.

The binder in the first ink-receiving layer and the binder in the second ink-receiving layer may be the same or different from each other.

The binder to used includes a water-soluble resin, and the examples thereof include polyvinyl alcohol (including modified polyvinyl alcohol such as acetoacetyl-modified polyvinyl alcohol, carboxy-modified polyvinyl alcohol, itaconic acid-modified polyvinyl alcohol, maleic acid-modified polyvinyl alcohol, silica-modified polyvinyl alcohol or amino group-modified polyvinyl alcohol), methyl cellulose, carboxymethyl cellulose, starch (including modified starch), gelatin, gum arabic, casein, styrene-anhydrous maleate copolymer hydrolysate, polyacrylamide and saponified vinyl acetate-polyacrylic acid copolymer. Further, examples of the binder include a latex-based binder of a synthetic polymer such as styrene-butadiene copolymer, vinyl acetate copolymer, acrylonitrile-butadiene copolymer, methyl acrylate-butadiene copolymer and polyvinylidene chloride.

Polyvinyl Alcohol

The polyvinyl alcohol includes polyvinyl alcohol obtained by saponifying lower alcohol solution of polyvinyl acetate, and derivative of the polyvinyl alcohol, and further includes a saponified copolymer of vinyl acetate and a monomer capable of being copolymerizied with vinyl acetate. Examples of the monomer capable of being copolymerized with vinyl acetate include unsaturated carboxylic acid such as (anhydrous) maleic acid, fumaric acid, crotonic acid, itaconic acid, or (meth)acrylic acid, and ester thereof; α-olefin such as ethylene or propylene; olefin sulfonic acid such as (meth)allyl sulfonic acid, ethylene sulfonic acid, or maleate sulfonic acid; alkali salt of olefin sulfonic acid such as sodium (meth)allyl sulfonate, sodium ethylene sulfonate, sodium (meth)acrylate sulfonate, sodium (monoalkyl maleate) sulfonate, or sodium alkyl maleate disulfonate; and amide group-containing monomer such as N-methylol acrylamide, or alkali salt of acrylamide alkylsulfonate, and a derivative of N-vinylpyrrolidone.

Among the polyvinyl alcohols, polyvinyl alcohol having a saponification degree of from 92 mol % to 98 mol % (hereinafter, referred to as “polyvinyl alcohol with a high saponification degree”) is preferred.

When the saponification degree of the polyvinyl alcohol is 92 mol % or more, excellent halftone color hue can be obtained, and increase in viscosity of the coating liquid can be effectively suppressed, and excellent coating stability can be obtained.

When the saponification degree of the polyvinyl alcohol is 98 mol % or less, ink absorbency can be further improved.

The saponification degree of the polyvinyl alcohol is more preferably from 93 mol % to 97 mol %.

The polymerization degree of the polyvinyl alcohol with a high saponification degree is preferably from 1,500 to 3,600, and more preferably from 2,000 to 3,500. When the polymerization degree is 1,500 or more, cracks in the ink-receiving layer can be more efficiently suppressed. When the polymerization degree is 3,600 or less, increase in viscosity of the coating liquid can be more efficiently suppressed.

In the invention, as a binder, a water-soluble resin other than the polyvinyl alcohol with a high saponification degree can be used in combination with the polyvinyl alcohol with a high saponification degree. Examples of the water-soluble resin include a resin having a hydroxyl group as hydrophilic structure unit such as polyvinyl alcohol (PVA) having a saponification degree other than the range described above, cation-modified polyvinyl alcohol, anion-modified polyvinyl alcohol, silanol-modified polyvinyl alcohol, polyvinyl acetal, cellulose-based resin (for example, methyl cellulose (MC), ethyl cellulose (EC), hydroxyethyl cellulose (HEC), carboxymethyl cellulose (CMC), hydroxypropyl cellulose (HPC), or the like), chitins, chitosans, starch; a resin having a hydrophilic ether bond such as polypropylene oxide (PPO), polyethylene glycol (PEG), polyvinyl ether (PVE); or resin having a hydrophilic amide group or a hydrophilic amide bond such as polyacrylamide (PAAM), polyvinyl pyrrolidone (PVP). Further, examples of the water-soluble resin include a resing having a carboxyl group as a dissociative group such as a polyacrylic acid salt, a maleic acid resin, an alginic acid salt, or gelatin.

When the polyvinyl alcohol with a high saponification degree and the water-soluble resin described above are used in combination, the ratio of the polyvinyl alcohol with a high saponification degree with respect to the total amount of the polyvinyl alcohol with a high saponification degree and the water-soluble resin is preferably from 1% by mass to 30% by mass, more preferably from 3% by mass to 20% by mass, and particularly preferably from 6% by mass to 12% by mass.

The content of the polyvinyl alcohol with a high saponification degree is preferably from 9% by mass to 40% by mass, and more preferably from 12% by mass to 33% by mass with respect to the total solid mass of the ink-receiving layer, from the viewpoints of preventing a decrease in film strength or an occurrence of cracking while drying, which are induced by an excessively low content of the polyvinyl alcohol with a high saponification degree, and from the viewpoints of preventing reduction in ink-absorbency that results from decrease in porosity due to an increased tendency for pores to be clogged by the resins, which is induced by excessively high content of the polyvinyl alcohol with a high saponification degree.

The polyvinyl alcohol has hydroxyl groups in the structural unit, and the hydroxyl groups and the silanol groups on the surface of the silica fine particles form hydrogen bonding, whereby a three-dimensional network structure having secondary particles of the silica fine particles as chain units is easily formed. It is considered that a porous-structured ink-receiving layer having high porosity can be formed by the formation of such a three-dimensional network structure.

In the ink jet recording medium, the porous ink-receiving layer obtained in the above manner can absorb ink rapidly by capillary action and form excellent true-circularly dots without ink bleeding.

Content Ratio of Pigment to Binder

The content ratio of the pigment (x) to the binder (y) in the ink-receiving layer (PB ratio (x/y), the mass of the pigment with respect to 1 part by mass of the binder) also has a large influence on the film structure of the ink-receiving layer. In other word, as the PB ratio increases, porosity, pore volume and surface area (per unit mass) increase. Specifically, the PB ratio (x/y) of the all ink-receiving layers is preferably from 1.5/1 to 10/1 from the viewpoints of preventing a decrease in film strength and cracks while drying, which are induced by an excessively high PB ratios and from the viewpoints of preventing reduction in ink absorbency that results from decrease in porosity due to an increased tendency for pores to be clogged by the resins, which is induced by excessively low PB ratios.

The PB ratio (x/y) of the first ink-receiving layer is preferably from 5/1 to 20/1, and more preferably from 10/1 to 20/1, from the viewpoints of further improving ink absorbency.

The PB ratio (x/y) of the second ink-receiving layer is preferably from 1.5/1 to 10/1, and more preferably from 1.5/1 to 8/1, from the viewpoints of effectively preventing a decrease in film strength and cracks while drying.

When passing through the transport system of an inkjet printer, the inkjet recording medium is subjected to stress in some cases; therefore, the ink-receiving layer preferably has sufficient film strength. The sufficient strength of the ink-receiving layer is favorable also from the standpoint of avoiding the occurrence of cracking and detachment of the ink-receiving layer when the recording medium is cut into sheets. In view of these cases, the PB ratio (x/y) of the all ink-receiving layers is preferably 10/1 or less.

For example, when a coating liquid prepared by completely dispersing fumed silica having an average primary particle diameter of 20 nm or less and the polyvinyl alcohol with a high saponification degree at the PB ratio (x/y) of from 1.5/1 to 10/1 in a solution is applied onto a substrate and the resultant coating layer is dried, a three-dimensional network structure is formed which has secondary particles of the fumed silica fine particles as network chains, whereby a light-transmitting porous film having an average pore diameter of 30 nm or less, a porosity of from 50% to 80%, a specific pore volume of 0.5 ml/g or more, and a specific surface area of 100 m²/g or more can be easily formed.

Boron Compound

At least the first ink-receiving layer of the invention contains at least one kind of boron compound.

It is preferred that at least the second ink-receiving layer contains at least one kind of boron compound.

Further, it is preferred that the boron compound is used as a crosslinking agent in the ink-receiving layer. In other words, the ink-receiving layer of the invention is preferably a porous layer which is cured through crosslinking reaction of the binder (for example, polyvinyl alcohol) by the boron compound.

Examples of the boron compound include borax, boric acid, borates (such as orthoborate, InBO₃, ScBO₃, YBO₃, LaBO₃, Mg₃(BO₃)₂, Co₃(BO₃)₂), diborates (such as Mg₂B₂O₅, Co₂B₂O₅), metaborates (such as LiBO₂, Ca(BO₂)₂, NaBO₂, KBO₂), tetraborates (such as Na₂B₄O₇.10H₂O), pentaborates (such as KB₅O₈.4H₂O, CsB₅O₅), and jexaborates (such as Ca₂B₆O₁₁.7H₂O). Of these, from the viewpoint of rapidness of crosslinking reaction, borax, boric acid, and borates are preferred, and boric acid or borate is particularly preferred and it is most preferable to use boric acid or borate in combination with polyvinyl alcohol.

The boron compound is preferably included in the all ink-receiving layers at an amount of from 0.05 parts by mass to 0.50 parts by mass, and more preferably from 0.08 parts by mass to 0.45 parts by mass, with respect to 1.0 part by mass of the polyvinyl alcohol. When the content of the boron compound is in the above range, the polybinyl alcohol is effectively crosslinked thereby preventing cracks or the like.

When the gelatin is used as the binder (the water soluble resin), the following compounds other than the boron compound may be used as a crosslinking agent (hereinafter, referred to as “other crosslinking agents”).

Examples of other crosslinking agents include aldehyde compounds such as formaldehyde, glyoxal and gultaraldehyde; ketone compounds such as diacetyl and cyclopentanedione; active halogen compounds such as bis(2-chloroethylurea)-2-hydroxy-4,6-dichloro-1,3,5-triazine and sodium salts of 2,4-dichloro-6-s-triazine; active vinyl compounds such as divinylsulfonic acid, 1,3-bis(vinylsulfonyl)-2-propanol, N,N′-ethylenebis(vinylsulfonylacetamide) and 1,3,5-triacryloyl-hexahydro-s-triazine; N-methylol compounds such as dimethylolurea and methyloldimethylhydantoin; melamine resins such as methylolmelamine and alkylated methylolmelamine; epoxy resins;

isocyanate compounds such as 1,6-hexamethylene diisocyanate; the aziridine compounds described in U.S. Pat. Nos. 3,017,280 and 2,983,611; the carboxyimide compounds described in U.S. Pat. No. 3,100,704; epoxy compounds such as glycerol triglycidyl ether; ethyleneimino compounds such as 1,6-hexamethylene-N,N′-bisethyleneurea; halogenated carboxyaldehyde compounds such as mucochloric acid and mucophenoxychloric acid; dioxane compounds such as 2,3-dihydroxydioxane; metal-containing compounds such as titanium lactate, aluminum sulfate, chrome alum, potassium alum, zirconyl acetate and chromium acetate; polyamine compounds such as tetraethylenepentamine; hydrazide compounds such as adipic acid dihydrazide; and low-molecular compounds or polymers each having at least two oxazoline groups. The other crosslinking agents may be used alone or may be used in combination of two or more kinds thereof.

Nitrogen-Containing Organic Cationic Polymer

It is preferred that the ink-receiving layer of the invention (at least one of the first ink-receiving layer and the second ink-receiving layer) contains at least one nitrogen-containing organic cationic polymer from the viewpoint of suppressing bleeding of a recorded image and the viewpoint of dispersing silica.

The nitrogen-containing organic cationic polymer of the invention is not specifically limited, but a polymer having a primary amino group, a secondary amino group, a tertiary amino group or a quaternary ammonium salt is preferred.

Examples of the nitrogen-containing organic cationic polymer include a nitrogen-containing organic cationic polymer which is a homopolymer of the monomer (nitrogen-containing organic cation monomer) having the a primary to a tertiary amino group or a salt thereof or a quaternary ammonium salt group; a nitrogen-containing organic cationic polymer obtained as a copolymer or condensate of the nitrogen-containing organic cation monomer and other monomers; a conjugated diene copolymer such as styrene-butadiene copolymer, methylmethacrylate-butadiene copolymer; an acrylic polymer such as a polymer or copolymer of acrylic acid ester and methacrylic acid ester, a polymer or copolymer of acrylic acid and methacrylic acid; a styrene-acryl polymer such as styrene-acrylic acid ester copolymer, styrene-methacrylic acid ester copolymer; a vinyl polymer such as ethylene vinyl acetate copolymer; a nitrogen-containing organic cationic polymer obtained by cationically modifying a urethane polymer having a urethane bond by using a compound having a cationic group.

Examples of the nitrogen-containing organic cation monomer include trimethyl-p-vinyl benzyl ammonium chloride, trimethyl-m-vinyl benzyl ammonium chloride, triethyl-p-vinyl benzyl ammonium chloride, triethyl-m-vinyl benzyl ammonium chloride, N,N-dimethyl-N-ethyl-N-p-vinyl benzyl ammonium chloride, N,N-diethyl-N-methyl-N-p-vinyl benzyl ammonium chloride, N,N-dimethyl-N-n-propyl-N-p-vinyl benzyl ammonium chloride, N,N-dimethyl-N-n-octyl-N-p-vinyl benzyl ammonium chloride, N,N-dimethyl-N-benzyl-N-p-vinyl benzyl ammonium chloride, N,N-diethyl-N-benzyl-N-p-vinyl benzyl ammonium chloride, N,N-dimethyl-N-(4-methyl)benzyl-N-p-vinyl benzyl ammonium chloride, N,N-dimethyl-N-phenyl-N-p-vinyl benzyl ammonium chloride;

trimethyl-p-vinyl benzyl ammonium bromide, trimethyl-m-vinyl benzyl ammonium bromide, trimethyl-p-vinyl benzyl ammonium sulfonate, trimethyl-m-vinyl benzyl ammonium sulfonate, trimethyl-p-vinyl benzyl ammonium acetate, trimethyl-m-vinyl benzyl ammonium acetate, N,N,N-triethyl-N-2-(4-vinylphenyl)ethyl ammonium chloride, N,N,N-triethyl-N-2-(3-vinylphenyl)ethyl ammonium chloride, N,N-diethyl-N-methyl-N-2-(4-vinylphenyl)ethyl ammonium chloride, N,N-diethyl-N-methyl-N-2-(4-vinylphenyl)ethyl ammonium acetate;

a quaternarized compound obtained by reacting N,N-dimethyl aminoethyl (meth)acrylate, N,N-diethyl aminoethyl (meth)acrylate, N,N-dimethyl aminopropyl (meth)acrylate, N,N-diethylaminopropyl (meth)acrylate, N,N-dimethyl aminoethyl (meth)acrylamide, N,N-diethyl aminoethyl (meth)acrylamide, N,N-dimethyl aminopropyl (meth)acrylamide, or N,N-diethylaminopropyl (meth)acrylamide, with methyl chloride, ethyl chloride, methylbromide, ethyl bromide, methyl iodide or ethyl iodide, or a sulfonic acid salt, an alkylsulfonic acid salt, an acetic acid salt or an alkylcarboxylic acid salt, each of which is obtained by anion substitution of the above quaternarized compound.

Examples of the specific compound include monomethyl diallyl ammonium chloride, trimethyl-2-(methacryloyloxy)ethyl ammonium chloride, triethyl-2-(methacryloyloxy)ethyl ammonium chloride, trimethyl-2-(acryloyloxy)ethyl ammonium chloride, triethyl-2-(acryloyloxy)ethyl ammonium chloride, trimethyl-3-(methacryloyloxy)propyl ammonium chloride, triethyl-3-(methacryloyloxy)propyl ammonium chloride, trimethyl-2-(methacryloylamino)ethyl ammonium chloride, triethyl-2-(methacryloylamino)ethyl ammonium chloride, trimethyl-2-(acryloylamino)ethyl ammonium chloride, triethyl-2-(acryloylamino)ethyl ammonium chloride, trimethyl-3-(methacryloylamino)propyl ammonium chloride, triethyl-3-(methacryloylamino)propyl ammonium chloride, trimethyl-3-(acryloylamino)propyl ammonium chloride, triethyl-3-(acryloylamino)propyl ammonium chloride;

N,N-dimethyl-N-ethyl-2-(methacryloyloxy)ethyl ammonium chloride, N,N-diethyl-N-methyl-2-(methacryloyloxy)ethyl ammonium chloride, N,N-dimethyl-N-ethyl-3-(acryloylamino)propyl ammonium chloride, trimethyl-2-(methacryloyloxy)ethylammonium bromide, trimethyl-3-(acryloylamino)propyl ammonium bromide, trimethyl-2-(methacryloyloxy)ethylammonium sulfonate, and trimethyl-3-(acryloylamino)propyl ammonium acetate. Examples of the copolymerizable monomer include N-vinylimidazole, and N-vinyl-2-methylimidazole. N-vinylacetamide, N-vinylformamide, or the like may be used for polymerization, and the resultant polymer may be hydrolyzed to generate an amine unit. This unit may be converted to form a salt.

The other monomers capable of being copolymerized (or condansation-polymerized) with the nitrogen-containing organic cation monomer may be a monomer which does not contain a basic or cationic portion such as a primary to tertiary amino group or a salt thereof or a quaternary ammonium salt group, and which does not interact or has substantially low interaction with a dye in an inkjet ink. The examples thereof include alkyl (meth)acrylic ester; cycloalkyl (meth)acrylic ester such as cylohexyl (meth)acrylate; aryl (meth)acrylic ester such as phenyl (meth)acrylate; aralkyl ester such as benzyl (meth)acrylate; aromatic vinyls such as styrene, vinyltoluene, or a-methylstyrene; vinylesters such as vinyl acetate, vinyl propionate, or vinyl versatate; allyl esters such as allyl acetate; a halogen-containing monomer such as vinylidene chloride, or vinyl chloride; vinyl cyanide such as (meth)acrylonitrile; and olefins such as ethylene or propylene.

For example, the alkyl (meth)arylic ester is preferably alkyl (meth)acrylic ester having from 1 to 18 carbon atoms at an alkyl site. Specific examples thereof include methyl (meth)acrylate, ethyl (meth)acrylate, propyl (meth)acrylate, isopropyl (meth)acrylate, n-butyl (meth)acrylate, isobutyl(meth)acrylate, t-butyl (meth)acrylate, hexyl (meth)acrylate, octyl (meth)acrylate, 2-ethylhexyl (meth)acrylate, lauryl (meth)acrylate, and stearyl (meth)acrylate. Among them, methyl acrylate, ethyl acrylate, methyl methacrylate, ethyl methacrylate, and hydroxyethyl methacrylate are preferred. The other monomers may be used alone or in combination of two or more kinds.

Further, examples of a monomer forming the urethane polymer include a polyvalent isocyanate compound having two or more isocyanate groups (such as 2,4-tolylene diisocyanate, 2,6-tolylene diisocyanate, m-phenylene diisocyanate, 4,4′-diphenyl methane diisocyanate, hexamethylene diisocyanate, octamethylene diisocyanate, 1,4-cyclohexylene diisocyanate, isophorone diisocyanate, 1,3-bis(methylisocyanate)-cylcohexane, 1,5-diisocyanate-2-methylpentane, hydrogenated xylylene diisocyanate, or hydrogenated 4,4′-diphenyl methane diisocyanate) and a compound which reacts with an isocyanate group so as to form a urethane bond (for example, a polyol compound such as glycerin, 1,6-hexanediol, triethanolamine, polypropylene glycol, polyethylene glycol, bisphenol A, hydroquinone; succinic acid, adipic acid, azelaic acid, sebacinic acid, dodecanedicarboxylic acid, maleic anhydride, fumaric acid, 1,3-cyclopentane dicarboxylic acid, 1,4-cyclohexane dicarboxylic acid, terephthalic acid, isophthalic acid, phthalic acid, 1,4-naphthalene dicarboxylic acid, 2,5-naphthalene dicarboxylic acid, 2,6-naphthalene dicarboxylic acid, naphthalene acid, biphenyl carboxylic acid, sorbitol, saccharose, aconitic acid, trimellitic acid, hemimellitic acid, phosphoric acid, pyrogallol, dihydroxybenzoic acid, hydroxyphthalic acid, 1,2,3-propanetrithiol; diamine such as ethylene diamine, propylene diamine, diethylenetriamine, triisopropanolamine, hexamethylene diamine, phenylene diamine, tolylene diamine, diphenyl diamine, diaminodiphenyl methane, diaminocyclohexylmethane, piperazine, isophorone diamine; or hydrazine).

Further, examples of the compound in which a cationic group is introduced into a copolymer or condensation polymer that do not have cationic groups include alkyl halides and methyl sulfate.

Among the nitrogen-containing organic cationic polymers, from the viewpoint of suppressing bleeding, cationic polyurethane and cationic polyacrylate described in JP-A No. 2004-167784 are preferred, and cationic polyurethane is more preferred. Examples of the commercially available product of the cationic polyurethane include “SUPER FLEX 650”, “SUPER FLEX 650-5”, “F-8564D”, “F-8570D” (trade name, manufactured by Dai-Ichi Kogyo Seiyaku Co., Ltd.), and “NEOFIX IJ-150” (trade name, manufactured by Nicca Chemical Co., Ltd.).

From the viewpoints of pigment dispersion, polydiallyl dimethyl ammonium chloride, and a polymethacryloyloxyethyl-β-hydroxyethyl dimethyl ammonium chloride derivative are preferable, and polydiallyl dimethyl ammonium chloride is more preferable.

Examples of the commercially available product thereof includes “SHALLOL DC 902P (trade name)” manufactured by Dai-ichi Kogyo Seiyaku Co., Ltd.

Further, as the nitrogen-containing organic cationic polymer, cation-modified self-emulsifying polymers described in paragraphs from 0018 to 0046 of JP-A No. 2007-223119 may be used.

The nitrogen-containing organic cationic polymer may be used as a water-soluble polymer, water dispersible latex particles, and aqueous emulsion.

Examples of the aqueous emulsion include conjugation diene-based copolymer emulsion; acryl-based polymer emulsion; styrene-acryl-based polymer emulsion; vinyl-based polymer emulsion; one where urethane-based emulsion is cationized by using a compound having a cationic group, one where the surface of an emulsion is cationized with a cationic surfactant, one where cationic polyvinyl alcohol is polymerized, and the polyvinyl alcohol is disposed on the surface of the emulsion. Among these cationic emulsions, cationic polyurethane emulsion which contains urethane emulsion as the main component is preferred.

In the invention, the nitrogen-containing organic cationic polymer contained in the the ink-receiving layer is preferably cationic polyurethane and more preferably cationic polyurethane emulsion, from the viewpoints of suppression of bleeding.

Water-Soluble Aluminum Compound

It is preferred that the ink-receiving layer of the invention (at least one of the first ink-receiving layer and the second ink-receiving layer) contains a water-soluble aluminum compound.

When the water-soluble aluminum compound is used, water resistance and bleeding resistance over time of formed image can be improved.

Examples of the water-soluble aluminum compound include a known inorganic salt such as aluminum chloride or hydrate thereof, aluminum sulfate or hydrate thereof, or ammonium alum. Further, the examples thereof include a basic polyaluminum hydroxide compound which is an inorganic aluminum-containing cationic polymer. Among them, the basic polyaluminum hydroxide compound is preferred.

The basic polyaluminum hydroxide compound represents a water-soluble polyalumium hydroxide which stably includes a basic polymeric multinuclear condensation ion such as [Al₆(OH)₁₅]³⁺, [Al₈(OH)₂₀]⁴⁺, [Al₁₃(OH)₃₄]⁵⁺, [Al₂₁(OH)₆₀]³⁺, represented by the following formulae 1, 2 or 3 as the main component.

[Al₂(OH)ₙCl₆₋ₙ]ₘ (5<m<80, 1<n<5) (formula 1)

[Al(OH)₃]ₙAlCl₃ (1<n<2) (formula 2)

Alₙ(OH)ₘCl₍₃ₙ₋ₘ₎ (0<m<3n, 5<m<8) (formula 3)

These compounds are available from from Taki Chemical Co., Ltd. as a water treatment agent under the trade name of POLYALUMINUM CHLORIDE (PAC), from Asada Chemical INDUSTRY Co. LTD. under the trade name of POLYALUMINUM HYDROXIDE (Paho), from RIKENGREEN CO., LTD. under the trade name of PURACHEM WT, from TAIMEI CHEMICALS Co., Ltd. under the trade name of ALFINE 83, or from other manufacturers as products for similar applications, and products of of various grade are available. In the invention, these commercially available products can be used without any processing. However, when the pH of the commercially available product is unsutably low, the pH may be adjusted suitably.

The content of the water-soluble aluminum compound in the ink-receiving layer of the invention is preferably from 0.1% by mass to 20% by mass, more preferably from 1% by mass to 8% by mass, and most preferably from 2% by mass to 4% by mass, with respect to the total solid content of the ink-receiving layer, from the viewpoints of improving glossiness, water resistance, gas resistance, and light resistance.

Zirconium Compound

It is preferred that the ink-receiving layer of the invention (at least one of the first ink-receiving layer and the second ink-receiving layer, particularly preferably at least the second ink-receiving layer) contains a zirconium compound.

When the zirconium compound is used, water resistance is increased.

The zirconium compound used in the invention is not specifically limited, and various zirconium compounds can be used. The examples thereof include zirconyl acetate, zirconium chloride, zirconium oxychloride, zirconium hydroxychloride, zirconium nitrate, basic zirconium carbonate, zirconium hydroxide, ammonium zirconium carbonate, potassium zirconium carbonate, zirconium sulfate, and zirconium fluoride. Zirconyl acetate is particularly preferred.

The content of the zirconium compound in the ink-receiving layer of the invention is preferably from 0.05% by mass to 5.0% by mass, more preferably from 0.1% by mass to 3.0% by mass, and most preferably from 0.5% by mass to 2.0% by mass with respect to the total solid content of the ink-receiving layer, from the viewpoints of improving water resistance without deteriorating ink absorbency.

In the invention, other water-soluble multivalent metal compounds other than the water-soluble aluminum compound and the zirconium compound described above may further be used. Examples of the additional water-soluble multivalent metal compounds include a water-soluble salt of metal selected from calcium, barium, manganese, copper, cobalt, nickel, iron, zinc, chromium, magnesium, tungsten and molybdenum.

Specific examples thereof include calcium acetate, calcium chloride, calcium formate, calcium sulfate, barium acetate, barium sulfate, barium phosphate, manganese chloride, manganese acetate, manganese formate dihydrate, manganese ammonium sulfate hexahydrate, cupric chloride, ammonium cupric chloride dihydrate, copper sulfate, cobalt chloride, cobalt thiocyanate, cobalt sulfate, nickel sulfate hexahydrate, nickel chloride hexahydrate, nickel acetate tetrahydrate, nickel ammonium sulfate hexahydrate, nickel amide sulfate tetrahydrate, ferrous bromide, ferrous chloride, ferric chloride, ferrous sulfate, ferric sulfate, zinc bromide, zinc chloride, zinc nitrate hexahydrate, zinc sulfate, chromium acetate, chromium sulfate, magnesium sulfate, magnesium chloride hexahydrate, magnesium citrate 9-hydrate, sodium phosphorus tungstate, sodium tungsten citrate, 12 tungsten phosphate n-hydrate, 12 tungstosilicate 26-hydrate, molybdenum chloride, and 12 molybdenum phosphate n-hydrate.

Other Components

The ink-receiving layer in the present invention (at least one of the first ink-receiving layer and the second ink-receiving layer) may contain the following components if necessity.

That is, the ink-receiving layer may include an anti-fading agent such as a variety of ultraviolet absorbents, antioxidants, and singlet oxygen quenchers, for the purpose of suppressing degradation of ink color materials.

Examples of the ultraviolet absorbent include cinnamic acid derivative, benzophenone derivative, and benzotriazolylphenol derivative. Specific examples thereof include butyl α-cyano-phenyl cinnamate, o-benzo triazolylphenol, o-benzo triazole-p-chlorophenol, o-benzo trizole-2, 4-di-t-butylphenol, and o-benzo triazole-2,4-di-t-octylphenol. A hindered phenol compound also can be used as the ultraviolet absorbent, and specifically, a phenol derivative in which at least one or more of the position two and position six are substituted with branched alkyl groups is preferred.

Further, benzotriazole ultraviolet absorbent, salicylic acid ultraviolet absorbent, cyanoacrylate ultraviolet absorbent, and oxalic acid anilide ultraviolet absorbent may be used. Examples, thereof are described, for example, in JP-A No.47-10537, JP-A No.58-111942, JP-A No.58-212844, JP-A No.59-19945, JP-A No.59-46646, JP-A No.59-109055, JP-A No.63-53544, Japanese Patent Application Publication (JP-B) No.36-10466, JP-B No.42-26187, JP-B No.48-30492, JP-B No.48-31255, JP-B No.48-41572, JP-B No.48-54965, JP-B No.50-10726, U.S. Pat. No. 2,719,086, U.S. Pat. No.3,707,375, U.S. Pat. No.3,754,919, and U.S. Pat. No. 4,220,711.

A fluorescent brightener can also be used as the ultraviolet absorbent, and examples of the fluorescent brightener include a coumalic fluorescent brightener. Examples thereof are described, for example, in JP-B No. 45-4699 and JP-B No. 54-5324.

Examples of the antioxidant include an antioxidant such as those described in European Patent (EP) No. 223739, EP No. 309401, EP No. 309402, EP No. 310551, EP No. 310552, EP No. 459416, German Patent (GP) No.3435443, JP-A No. 54-48535, JP-A No.60-107384, JP-A No.60-107383, JP-A No.60-125470, JP-A No.60-125471, JP-A No.60-125472, JP-A No.60-287485, JP-A No.60-287486, JP-A No.60-287487, JP-A No.60-287488, JP-A No.61-160287, JP-A No.61-185483, JP-A No.61-211079, JP-A No.62-146678, JP-A No.62-146680, JP-A No.62-146679, JP-A No.62-282885, JP-A No.62-262047, JP-A No.63-051174, JP-A No.63-89877, JP-A No.63-88380, JP-A No.66-88381, JP-A No.63-113536;

JP-A No.63-163351, JP-A No.63-203372, JP-A No.63-224989, JP-A No.63-251282, JP-A No.63-267594, JP-A No.63-182484, JP-A No.1-239282, JP-A No. 2-262654, JP-A No. 2-71262, JP-A No.3-121449, JP-A No.4-291685, JP-A No.4-291684, JP-A No.5-61166, JP-A No.5-119449, JP-A No.5-188687, JP-A No.5-188686, JP-A No.5-110490, JP-A No.5-1108437, JP-A No.5-170361 , JP-B No.48-43295, JP-B No.48-33212, U.S. Pat. No. 4814262, and U.S. Pat. No.4980275.

Specific examples of the antioxidant include 6-ethoxy-1-phenyl-2, 2, 4-trimethyl-1,2-dihydroquinoline, 6-ethoxy-1-octyl-2,2,4-trimethyl-1,2-dihydroquinoline, 6-ethoxy-1-phenyl-2,2,4-trimethyl-1,2,3,4-tetrahydroquinoline, 6-ethoxy-1-octyl-2,2,4-trimethyl-1,2,3,4,-tetrahydroquinoline, nickel cyclohexanoate, 2,2-bis(4-hydroxyphenyl)propane, 1,1-bis(4-hydroxyphenyl)-2-ethylhexane, 2-methyl-4-methoxy-diphenylamine, and 1-methyl-2-phenylindole.

The anti-fading agent may be used alone, or two or more thereof may be used in combination. The anti-fading agent may be water-solubilized, dispersed, or emulsified, and may be contained in a micro capsule. The amount of the anti-fading agent to be added is preferably from 0.01% by mass to 10% by mass of the coating liquid for forming the ink-receiving layer.

In the present invention, the ink-receiving layer preferably contains a high-boiling-point organic solvent for prevention of curling. The high-boiling-point organic solvent is preferably water-soluble, and examples of the water-soluble high-boiling-point organic solvent include alcohols such as ethylene glycol, propylene glycol, diethylene glycol, triethylene glycol, glycerin, diethylene glycol monobutyl ether (DEGMBE), triethylene glycol monobutyl ether, glycerin monomethyl ether, 1,2,3-butanetriol, 1,2,4-butanetriol, 1,2,4-pentanetriol, 1,2,6-hexanetriol, thiodiglycol, triethanolamine, polyethylene glycol (weight-average molecular weight of 400 or less), and diethylene glycol monobutyl ether (DEGMBE) is preferred.

The content of the high-boiling-point organic solvent in the coating liquid for the ink-receiving layer is preferably from 0.05% by mass to 1% by mass, and particularly preferably from 0.1% by mass to 0.6% by mass.

The ink-receiving layer may contain, for example, various inorganic salts and acid or alkali as a pH adjuster for the purpose of increasing a dispersibility of the inorganic fine particles.

The ink-receiving layer may also contain metal oxide fine particles having electroconductivity for the purpose of suppressing the electrification of the surface of the ink-receiving layer due to the friction or separation, and various matt agents for the purpose of reducing friction at the surface of the ink-receiving layer.

The thickness of the ink-receiving layer of the invention is not specifically limited but, for example, the following thickness is preferred.

The thickness of the first ink-receiving layer is preferably from 1 μm to 50 μm, and more preferably from 2 μm to 30 μm, from the viewpoints of absorbency and suppression of a fingerprint mark.

The thickness of the second ink-receiving layer is preferably from 5 μm to 30 μm and more preferably from 10 μm to 30 μm, from the viewpoints of absorbency, density, and glossiness.

The thickness of the all ink-receiving layers including the first ink-receiving layer and the second ink-receiving layer is preferably from 10 μm to 60 μm and more preferably from 10 μm to 40 μm, from the viewpoints of absorbency.

The thickness of the ink-receiving layer is determined by exposing the cross-section of the sample (inkjet recording medium) by cutting with a razor a microtome, or the like, and measuring the thickness of the ink-receiving layer with an optical microscope.

Additional Layer

The inkjet recording medium of the invention may have, on the water-impermeable substrate, an additional layer other than the ink-receiving layer and for example, the inkjet recording medium may optionally have an uppermost layer (such as a colloidal silica layer, or the like), an intermediate layer and a functional layer having a function such as cushion property and antistatic property.

Water-Impermeable Substrate

The inkjet recording medium of the invention includes the all ink-receiving layers placed on a water impermeable substrate.

In the invention, “water-impermeable properties” represents properties in which no water is absorbed or a water absorption amount is 0.3 g/m² or less.

By using the water-impermeable substrate, deformation such as curling caused by image recording is suppressed.

In the invention, 60° glossiness of the surface of the water-impermeable substrate at a side at which the ink-receiving layer is to be formed is not specifically limited, but even when either a high glossiness substrate or a low glossiness substrate is used, a semi-gloss substrate can be manufactured. The 60° glossiness of the surface of the water-impermeable substrate is preferably 40% or more, more preferably from 45% to 95% , and even more preferably from 50% to 85%, from the viewpoints of broader substrate choices.

The water-impermeable substrate may be a transparent substrate made of a transparent material such as plastic or an opaque substrate made of an opaque material such as paper. In order to utilize the transparency of the ink-receiving layer, it is preferable to use a transparent substrate or a highly-glossy opaque substrate. Further, a read-only optical disk such as a CD-ROM or a DVD-ROM, a write-once optical disk such as a CD-R or a DVD-R, or a rewritable optical disk may be used as a substrate, and the ink-receiving layer may be applied onto the label surface side thereof.

The material of the transparent substrate is preferably transparent and resistant to radiation heat when the inkjet recording medium is used on an OHP or a back light display. Examples of the material include polyesters such as polyethylene terephthalate (PET), polysulfone, polyphenylene oxide, polyimide, polycarbonate, and polyamide. Among them, polyesters are preferable, and polyethylene terephthalate is particularly preferable.

The thickness of the transparent substrate has no particular limits, but it is preferably from 50 μm to 200 μm in view of easy-handling.

Examples of the opaque substrate include: high-gloss paper substrates such as art paper, coated paper, cast-coated paper, and baryta paper commonly used as silver salt photographic substrates; high-gloss films opacified by incorporating a white pigment or the like into plastic films such as polyesters (for example, polyethylene terephthalate (PET)), cellulose esters (for example, nitrocellulose, cellulose acetate, and cellulose acetate butyrate), polysulfone, polyphenylene oxide, polyimide, polycarbonate, or polyamide (wherein the surface of the high-gloss films may be subjected to a calender treatment); and substrates having a polyolefin coating layer containing, or not containing, a white pigment and formed on the surface of the various papers, the transparent substrates, or the high-gloss films containing a white pigment.

Foamed polyester films containing a white pigment (for example, a foamed PET having voids formed by stretching a PET that contains polyolefin fine particles) are also favorable. Polyolefin resin-coated papers having a structure formed by coating the surface of base paper with a polyolefin resin, such as resin-coated papers commonly used as photographic papers for silver salt photographs are also preferable.

While the thickness of the opaque substrate is not particularly limited, it is preferably in a range of from 50 μm to 300 μm from the viewpoint of ease of handling.

The surface of the substrate may be subjected to corona discharge treatment, glow discharge treatment, flame treatment, ultraviolet ray irradiation treatment or the like for improvement in wetting properties and adhesive properties.

Next, base paper used in a paper substrate such as a resin coated paper (polyolefin resin-coated paper) is described.

The main raw material of the base paper is wood pulp. When making the base paper, a synthetic pulp or a synthetic fiber may be optionally used in addition to the wood pulp. The synthetic pulp may be made of, for example, polypropylene, and the synthetic fiber may be, for example, a nylon fiber or a polyester fiber. As the wood pulp, any of LBKP, LBSP, NBKP, NBSP, LDP, NDP, LUKP or NUKP may be used. It is preferable to increase the total amount of LBKP, NBSP, LBSP, NDP and LDP, which have high contents of short fibers. However, the proportion of LBSP and/or LDP is preferably from 10% by mass to 70% by mass.

The pulp is preferably a chemical pulp (such as sulfate salt pulp or sulfite pulp), which has a low impurity content. A pulp of which whiteness is improved by bleaching is also useful.

To the base paper, one or more of the following may be added as necessary: a sizing agent such as a higher fatty acid or an alkylketene dimer, a white pigment such as calcium carbonate, talc or titanium oxide, a paper-strength enhancing additive such as starch, polyacrylamide or polyvinyl alcohol, a fluorescent brightener, a moisturizing agent such as polyethylene glycol, a dispersant, a softener such as quaternary ammonium, or the like.

The freeness, according to CSF (Canadian Standard Freeness), of the pulp used for paper-making is preferably from 200 mL to 500 mL. In regard to the fiber length after beating, the total sum of the percent by mass of the pulp remaining on a 24-mesh screen and the percent by mass of the pulp remaining on a 42-mesh screen according to JIS P-8207 (which is incorporated herein by reference) is preferably from 30% to 70% by mass. Further, the percent by mass of the pulp remaining on a 4-mesh screen is preferably 20% by mass or less.

The basis weight of base paper is preferably from 30 g/m² to 250 g/m², particularly preferably from 50 g/m² to 200 g/m². The thickness of the base paper is preferably from 40 μm to 250 μm. High smoothness may be imparted to the base paper by subjecting the base paper to calender treatment during or after papermaking The base paper density is generally from 0.7 g/m³ to 1.2 g/m³ (according to JIS P-8118, which is incorporated herein by reference). Furthermore, the stiffness of the base paper is preferably from 20 g to 200 g under conditions defined by JIS P-8143, which is incorporated herein by reference.

The base paper surface may be coated with a surface sizing agent, which may be selected from the above-described sizing agent that may be incorporated into the interior of the base paper.

The pH of the base paper is preferably from 5 to 9 as measured according to the hydrothermal extraction method defined by JIS P-8113, which is incorporated herein by reference.

The polyolefin (preferably polyethylene) coating the front and rear surfaces of the base paper mainly includes a low-density polyethylene (LDPE) and/or a high-density polyethylene (HDPE), and optionally includes a small amount of other polymers such as LLDPE or polypropylene.

In particular, a polyolefin layer (preferably a polyethylene layer) at a side on which the ink-receiving layer is to be formed preferably includes at least one of rutile-titanium oxide or anatase-titanium oxide, a fluorescent brightener, and ultramarine, which are commonly used in photographic papers, whereby opacity, whiteness and hue are improved. The content of titanium oxide is preferably in a range of from about 3% by mass to about 20% by mass, and more preferably in a range of from 4% by mass to 13% by mass, with respect to the polyolefin (preferably the polyethylene). The thickness of each of the polyolefin layer (preferably the polyethylene layer) on the front side and the polyethylene layer on the rear side is not particularly limited, but is preferably in a range of from 10 μm to 50 μm. In addition, an undercoat layer may be formed on the polyolefin layer (preferably the polyethylene layer) for increasing the adhesion thereof to an ink-receiving layer. The material of the undercoat layer preferably includes aqueous polyester, gelatin, and PVA. The thickness of the undercoat layer is preferably in a range of from 0.01 μm to 5 μm.

The polyolefin resin-coated paper (preferably, a polyethylene resin-coated paper) may be glossy paper, or paper having a matte or silky surface that is similar to that of common photographic printing paper and that has been formed by performing surface-finishing treatment when coating polyethylene on base paper by melt-extrusion.

The substrate may have a back coating layer. Examples of components that can be added to the back coating layer include a white pigment, an aqueous binder, and one or more other components.

Examples of the white pigment that may be contained in the back coating layer include a white inorganic pigment such as light calcium carbonate, heavy calcium carbonate, kaolin, talc, calcium sulfate, barium sulfate, titanium dioxide, zinc oxide, zinc sulfide, zinc carbonate, satin white, aluminum silicate, diatomaceous earth, calcium silicate, magnesium silicate, synthetic amorphous silica, colloidal silica, colloidal alumina, pseudo-boehmite, aluminum hydroxide, alumina, lithopone, zeolite, hydrated halloysite, magnesium carbonate, or magnesium hydroxide; and an organic pigment such as a styrene-containing plastic pigment, an acrylic plastic pigment, polyethylene, microcapsule, urea resin, or melamine resin.

Examples of the aqueous binder that may be used in the back coating layer include a water-soluble polymer such as styrene/maleate copolymer, styrene/acrylate copolymer, polyvinyl alcohol, silanol-modified polyvinyl alcohol, starch, cationized starch, casein, gelatin, carboxymethylcellulose, hydroxyethyl cellulose, or polyvinyl pyrrolidone; and water-dispersible polymer such as styrene butadiene latex, or acrylic emulsion.

Examples of the one or more other components that may be contained in the back coating layer include a defoamer, an anti-foaming agent, a dye, a fluorescent brightener, a preservative, and a water-resistant additive.

Method of Manufacturing Inkjet Recording Medium (Method of Producing Inkjet Recording Medium)

A method of producing the previously described inkjet recording medium of the invention is not specifically limited, but, for example, it is preferable that a method of producing an inkjet recording medium, the method including: forming an ink-receiving layer by simultaneously multilayer-coating, onto a water-impermeable substrate, at least a first coating liquid containing kaolin and a second coating liquid containing fumed silica in this order from a water-impermeable substrate side, wherein at least the first coating liquid further contains a boron compound, and the content ratio (% by mass) of boron in the total solid content of the first coating liquid is higher than the content ratio (% by mass) of boron in the total solid content of the second coating liquid (hereinafter, also “method of producing the inkjet recording medium of the invention”).

The method of producing the inkjet recording medium of the invention may include other processes, if necessary.

The descriptions, including preferable ranges and examples, of the ink-receiving layers, the glossiness, and the water-impermeable substrate in the explanation of the inkjet recording medium also apply to the ink-receiving layers, the glossiness, and the water-impermeable substrate in the production method.

In the method of producing the inkjet recording medium of the invention, the ink-receiving layer can be formed by applying, onto the water-impermeable substrate, the first coating liquid as a coating liquid for forming an ink-receiving layer to form a coating layer, and drying the coating layer, and the ink-receiving layer can be formed by applying, onto the ink-receiving layer that has been formed, the second-coating liquid as a coating liquid for forming an ink-receiving layer to form a coating layer, and drying the coating layer.

For example, when the ink-receiving layer of the inkjet recording medium of the invention has a two-layer structure, the first coating liquid is coated on the water-impermeable substrate to form the first ink-receiving layer and the second coating liquid is coated on the formed first ink-receiving layer to form the second ink-receiving layer.

In the method of producing the inkjet recording medium of the invention, when the content ratio (% by mass) of boron in the total solid content of the first coating liquid is defined as content ratio 1a and the content ratio (% by mass) of boron in the total solid content of the second coating liquid is defined as content ratio 2a, the ratio (content ratio 2a/content ratio 1a) is less than 1.00.

Through the study by the inventor, it is found that a coating liquid containing kaolin has less tendency to be gelatinized, compared to a coating liquid containing fumed silica, whereby surface defects such as occurence of a streak occur during coating. As a result of a further study, it is clearly found that when the content ratio (content ratio 2a/content ratio 1 a) is less than 1.00, surface defects can be effectively suppressed.

Therefore, when the method of producing the inkjet recording medium of the invention has a configuration described above, the inkjet recording medium of the invention having an excellent surface condition can be produced.

In the method of producing the inkjet recording medium of the invention, it is preferred that the second coating liquid further contains a boron compound. In this case, the ratio (content ratio 2a/content ratio 1a) is preferably from 0.10 to 0.90, more preferably from 0.30 to 0.90, and particularly preferably from 0.50 to 0.90, from the viewpoints of strength of the second ink-receiving layer and further improving surface condition of the inkjet recording medium.

Further, the content ratio 1a is preferably from 0.30% by mass to 2.00% by mass, and more preferably from 0.30% by mass to 1.80% by mass, from the viewpoints of further improving surface condition of the inkjet recording medium.

Furthermore, from the viewpoints of further improving surface condition of the inkjet recording medium, the inkjet recording medium of the invention preferably has a configuration in which the ratio (content ratio 2a/content ratio 1a) is within the preferable range thereof described above, and simultaneously, the content ratio 1a is within the preferable range thereof described above.

Further, the content ratio 2a is not specifically limited, so long as the ratio (content ratio 2a/content ratio 1a) is less than 1.00, but the content ratio 2a is preferably from 0.25% by mass to 1.80% by mass and more preferably from 0.25% by mass to 1.60% by mass, from the viewpoints of further improving strength of the second ink-receiving layer.

Coating Process

The method of producing the inkjet recording medium of the invention includes coating, onto the water-impermeable substrate, the first coating liquid and the second coating liquid in this order from the water-impermeable substrate (hereinafter, referred to as a “coating process”).

The method of coating the first coating liquid and the second coating liquid (and an additional coating liquid if necessary) is not specifically limited so long as the first coating liquid and the second coating liquid are displaced in this order from the water-impermeable substrate.

For example, the coating method may be a sequential coating method of separately coating layer by layer (for example, a blade coater, an air knife coater, a roll coater, a bar coater, Gravure coater, a reverse coater, or the like), or may be a simultaneously multilayer-coating method in which plural layers that form ink-receiving layers are simultaneously coated, or almost simultaneously coated without interposing a drying process therebetween (for example, slide bead coater or slide curtain coater, or the like). Further, for example, the coating method may be “Wet-On-Wet method” (hereinafter, “WOW method”) described in paragraph from 0016 to 0037 of JP-A No. 2005-14593.

Among them, from the viewpoints that properties required in each layer are effectively obtained and production efficiency is excellent, a simultaneously multilayer-coating method is preferably used. That is, in simultaneously multilayer-coating, when each of the layers is superposed in a wet state, a component contained in each of the layers, for example, the upper layer (for example, the second ink-receiving layer in the inkjet recording medium of the invention) is hardly penetrated into the lower layer (for example, the first ink-receiving layer in the inkjet recording medium of the invention), whereby the component is maintained in each of the layers after drying.

The simultaneously multilayer-coating can be performed using a known coating apparatus and, examples thereof includes a slide bead coater, a curtain flow coater, and an extrusion die coater.

In the invention, one or more other coating liquids may be further coated on the second coating liquid, if necessary. A barrier layer-coating liquid (intermediate layer coating liquid) may be interposed between each of the coating liquids.

Preferable coating amount of each of the coating liquids is described.

The coating amount of the first coating liquid in a solid content is preferably from 0.5 g/m² to 30 g/m² and more preferably from 1 g/m² to 20 g/m².

The coating amount of the second coating liquid in a solid content is preferably from 2 g/m² to 30 g/m² and more preferably from 5 g/m² to 20 g/m².

Hereinafter, the first coating liquid, the second coating liquid and the optilnal one or more other coating liquids are described.

First Coating Liquid

The first coating liquid contains a kaolin and a boron compound.

The kaolin may be used alone or in combination of two or more kinds, and the boron compound may be used alone or in combination of two or more kinds

The first coating liquid may further contain one or more other components such as a binder, a nitrogen-containing organic cationic polymer, a water-soluble aluminum compound, or a zirconium compound.

The descriptions, including preferable ranges and examples, of the kaolin, the boron compound, and the optional one or more other components in the first coating liquid in the explanation of the inkjet recording medium also apply to the kaolin, the boron compound, and the optional one or more other components in the first coating liquid in the production method.

The preferable range of content of kaolin in the total solid content of the first coating liquid has the same preferable range of content of kaolin in the total solid content of the first ink-receiving layer, and the preferable range of content of the boron compound in the total solid content of the first coating liquid has the same preferable range of content of the boron compound in the total content of the first ink-receiving layer.

The first coating liquid is preferably acidic, the pH thereof is preferably 5.0 or less, more preferably 4.5 or less and even more preferably 4.0 or less. The pH of the first coating liquid can be adjusted by suitably selecting the type or addition amount of the nitrogen-containing organic cationic polymer. The pH may be adjusted by adding an organic or inorganic acid. When the pH of the first coating liquid is 5.0 or less, for example, the crosslinking reaction of water-soluble resin (binder) by a crosslinking agent (particularly, the boron compound) contained in the first coating liquid can be sufficiently suppressed.

Example of Method of Preparing Rirst Coating Liquid

In the invention, the first coating liquid can be prepared, for example, as described below.

Kaolin and a dispersant are added to water (for example, kaolin in water is from 10% by mass to 20% by mass), and the resultant mixture is dispersed using a high speed rotating wet colloid mill (for example, “CLAIR MIX(trade name)” manufactured by M technique Co., Ltd) or a liquid-liquid collision dispersing machine (ULTIMAIZER, trade name, manufactured by Sugino Corporation). Into the dispersed mixture, aqueous polyvinyl alcohol (PVA) solution (for example, such that a mass of PVA is about ⅓ of the mass of kaolin described above), a boron compound, and a nitrogen-containing organic cationic polymer are added, further the aqueous aluminum compound is added, and dispersion is performed, thereby preparing the first coating liquid.

The water-soluble aluminum compound may be added by in-line mixing immediately before coating.

The dispersion can be carried out using the liquid-liquid collision dispersing machine (for example, ULTIMAIZER, trade name, manufactured by Sugino Corporation).

The obtained first coating liquid is in a uniform sol state. When the obtained first coating liquid is coated, on a substrate, by the following coating method and then dried, a porous ink-receiving layer having a three-dimensional network structure can be formed.

Regarding a preparation of an aqueous-dispersion including the kaolin and the dispersant, aqueous kaolin dispersion liquid prepared in advance may be added to a dispersant solution, the water dispersant solution may be added to the aqueous kaolin dispersion liquid, or the kaolin and the dispersant may be simultaneously mixed. A kaolin powder inplace of the aqueous kaolin may be added to the water dispersant solution.

The solvent used in each process may be water, an organic solvent, or a mixture thereof. Examples of the organic solvent that is usable for application include alcohols such as methanol, ethanol, n-propanol, i-propanol, and methoxy propanol; ketones such as acetone and methyl ethyl ketone; tetrahydrofuran, acetonitrile, ethyl acetate, and toluene.

The dispersant may be a cationic polymer. Examples of the cationic polymer include the mordants described in JP-A No. 2006-321176, paragraphs [0138] to [0148]. Alternatively, the use of a silane coupling agent as the dispersant is also preferable.

The addition amount of the dispersant with respect to the fine particles is preferably from 0.1% by mass to 30% by mass, and more preferably 1% by mass to 10% by mass.

Second Coating Liquid

The second coating liquid of the invention contains at least one kind of fumed silica.

From the viewpoints of promoting crosslinking and curing of the ink-receiving layer, it is preferred that the boron compound is contained in the second coating liquid.

The preferable range of content of fumed silica in the total solid content of the second coating liquid has the same preferable range of content of fumed silica in the total solid content of the second ink-receiving layer, and the preferable range of content of the boron compound in the total solid content of the second coating liquid has the same preferable range of content of the boron compound in the total solid content of the second-ink receiving layer.

The second coating liquid may further contain one or more other components such as a binder, a nitrogen-containing organic cationic polymer, a water-soluble aluminum compound, or a zirconium compound.

The descriptions, including preferable ranges and examples, of the fumed silica and the optional one or more other components in the second coating liquid in the explanation of the inkjet recording medium also apply to the fumed silica and the optional one or more other components in the second coating liquid in the production method.

The preparation method of the second coating liquid is not specifically limited, and the second coating liquid can be prepared, for example, in the same manner as in the preparation method of the first coating liquid described above except that fumed silica is used in place of the kaolin.

The second coating liquid is preferably acidic, the pH thereof is preferably 5.0 or less, more preferably 4.5 or less, and even more preferably 4.0 or less, similar to the first coating liquid. The pH can be adjusted by suitably selecting types or addition amount of nitrogen-containing cationic polymer. The pH may be adjusted by adding an organic or inorganic acid. When the pH of the second coating liquid is 5.0 or less, for example, crosslinking reaction of the binder can be suppressed sufficiently by a crosslinking agent (particularly, boron compound) in the second coating liquid.

Basic Solution Applying Process

It is preferable that the method of producing the inkjet recording medium of the present invention further includes applying, onto the ink-receiving layer, a basic solution containing a basic compound either
(1) at the same time with the formation of the ink-receiving layer (the coating layer) by applying the first coating liquid and the second coating liquid or
(2) during drying of the ink-receiving layer (the coating layer) formed by applying the first coating liquid and the second coating liquid but before the ink-receiving layer shows falling-rate drying.

The application of the basic solution in the method of producing the inkjet recording medium of the present invention further improves crosslinking and curing of the ink-receiving layer.

The application of the basic solution “at the same time with the formation of the ink-receiving layer by applying the first coating liquid and the second coating liquid” is preferably carried out by simultaneously coating (multilayer-coating) the first coating liquid and the second coating liquid (and, optionally, one or more other coating liquids) and the basic solution in this order from the substrate side.

The application of the basic solution “at the same time with the formation of the ink-receiving layer by applying the first coating liquid and the second coating liquid” may be carried out by applying the first coating liquid, and then simultaneously coating (hereinafter, referred to as “simultaneously multilayer-coating”) the second coating liquid and the basic solution on the applied first coating liquid.

The simultaneous coating (simultaneously multilayer-coating) may be performed with a known coating apparatus, such as an extrusion die coater or a curtain flow coater.

The application of the basic solution “during drying of the ink-receiving layer formed by applying the first coating liquid and the second coating liquid but before the ink-receiving layer shows falling-rate drying” is the method referred to as “Wet-On-Wet method” or “WOW method.” Details of the “Wet-On-Wet method” are described in, for example, JP-A No. 2005-14593, paragraphs [0016] to [0037].

In the invention, an ink-receiving layer (a coating layer) may be formed by simultaneously coating (simultaneously multilayer-coating), or separately coating layer by layer, the first coating liquid and the second coating liquid (and, optionally, one or more other coating liquids) in this order from the substrate side. After the formation of the ink-receiving layer (the coating layer), a basic solution may be applied to the ink-receiving layer (the coating layer) during drying of the ink-receiving layer thus formed but before the ink-receiving layer shows falling-rate drying, by (i) a method of further coating the basic solution on the thus-formed ink-receiving layer, (ii) a method of spraying the basic solution onto the thus-formed ink-receiving layer, or (iii) a method of immersing the substrate having the ink-receiving layer in the basic solution.

Methods that may be used for applying the basic solution in the method (i) include methods known in the art such as using a curtain flow coater, an extrusion die coater, an air doctor coater, a blade coater, a rod coater, a knife coater, a squeeze coater, a reverse roll coater and a bar coater. It is preferable to employ a method in which the coater does not directly contact an already-formed ink-receiving layer (coating layer), such as a method of using an extrusion die coater, a curtain flow coater, or a bar coater.

The expression “before the coating layer shows falling-rate drying” usually refers to a period of several minutes from immediately after the application of the ink-receiving layer coating liquids (in the present invention, the first coating liquid and the second coating liquid (and, optionally, one or more other coating liquids)), and, in this period, the applied coating layer shows the phenomenon of “constant-rate drying” whereby the solvent (dispersion medium) content in the coating layer decreases in proportion to a lapse of time. With respect to the period during which the constant-rate drying is observed, Kagaku Kogaku Binran (Handbook of Chemical Technology), pages 707-712, MARUZEN Co., Ltd. (Oct. 25, 1980) may be referenced, for example.

Drying until the coating layer begins to show falling-rate drying may be performed at 40° C. to 180° C. for 0.5 minutes to 10 minutes (preferably 0.5 minutes to 5 minutes). Although the drying time naturally varies with the coating amount, the range specified above is usually appropriate.

Basic Solution

Here, the basic solution is described.

The pH of the basic solution is preferably 7.1 or more, more preferably 8.0 or more, and particularly preferably 9.0 or more. When the pH is 7.1 or more, crosslinking reaction of the water-soluble resin (binder) which may be contained in the first coating liquid and/or the second coating liquid can be promoted and bronzing or cracks of the ink-receiving layer can be effectively suppressed.

Basic Compound

The basic solution contains at least one kind of basic compound.

Examples of the basic compound include ammonium salt of weak acid, alkali metal salt of weak acid (such as lithium carbonate, sodium carbonate, potassium carbonate, lithium acetate, sodium acetate, or potassium acetate), alkali earth metal salt of a weak acid (such as magnesium carbonate, barium carbonate, magnesium acetate, or barium acetate), hydroxylammonium, primary to tertiary amine (such as triethyl amine, tripropyl amine, tributylamine, trihexylamine, dibutylamine, or butylamine), primary to tertiary aniline (such as diethyl aniline, dibutyl aniline, ethyl aniline, or aniline), pyridine which may have a substituent group (such as 2-aminopyridine, 3-aminopyridine, 4-aminopyridine, or 4-(2-hydroxyethyl)-aminopyridine).

Other than the basic compounds described above, other basic materials and/or salts thereof can be used in combination with the basic compound. Examples of other basic materials include ammonia; primary amine such as ethyl amine, polyallylamine; secondary amine such as dimethyl amine; tertiary amine such as N-ethyl-N-methylbutylamine; and hydroxide of alkali metal or alkali earth metal.

Among them, ammonium salt of weak acid is particularly preferred. Weak acid means an inorganic and organic acid having a pKa of 2 or more described in the Kagaku Binran Kisohen II (Chemical Handbook Basic Edition II), MARUZEN Co., Ltd. Examples of the ammonium salt of the weak acid include ammonium carbonate, ammonium hydrogen carbonate, ammonium borate, ammonium acetate, and ammonium carbamate, however, the the ammonium salt of the weak acid is not limited thereto. Among them, ammonium carbonate, ammonium hydrogen carbonate, and ammonium carbamate are preferable and are effective from the viewpoints that there is no remains in the layer after drying, whereby ink bleeding can be reduced.

Two or more of the basic compounds may be used in combination.

The content of the basic compound (particularly ammonium salt of weak acid) in the basic solution is preferably from 0.5% by mass to 10% by mass and more preferably 1% by mass to 5% by mass, with respect to the total mass of basic solution (including solvent). When the content of the basic compound (particularly ammonium salt of weak acid) is in the range described above, a sufficient curing degree is obtained and imparing of a working environment due to the excessively high concentration of ammonia is prevented.

Boron Compound

It is preferred that the basic solution contains at least one boron compound described above, from the viewpoints of further promoting crosslinking and curing of the ink-receiving layer.

When the basic solution contains the boron compound, a boron compound may or may not be contained in the second coating liquid.

In a case of the basic solution containing the boron compound, when the content ratio (% by mass) of boron in the total solid content of the first coating liquid is defined as content ratio 1a and the content ratio (% by mass) of boron contained in total solid content of the second coating liquid and the basic solution is defined as content ratio 3a, the content ratio of boron is adjusted such that the ratio (content ratio 3a/content ratio 1a) is less than 1.00.

When the ratio (content ratio 3 a/content ratio 1a) is less than 1.00, gelation of the first coating liquid can be promoted and an increase in viscosity of the second coating liquid and basic solution can be suppressed, whereby the surface condition of the formed inkjet recording medium is further improved.

The ratio (content ratio 3 a/content ratio 1a) is preferably from 0.10 to 0.90, more preferably from 0.30 to 0.90 and particularly preferably from 0.50 to 0.90, from the viewpoints of strength of the second ink-receiving layer and further improving the surface condition of the inkjet recording medium.

The content ratio 1a is preferably from 0.30% by mass to 2.00% by mass, and more preferably from 0.30% by mass to 1.80% by mass, from the viewpoints of further improving the surface condition of the inkjet recording medium.

From the viewpoints of further improving surface condition of the inkjet recording medium, the inkjet recording medium of the invention preferable has a configuration in which the ratio (content ratio 3a/content ratio 1a) is within the preferable range thereof described above, and, simultaneously, the content ratio 1a is within the preferable range thereof described above.

Metal Compound

The basic solution in the invention may contain at least one metal compound.

Any metal compound that is stable under basic conditions may be used, without particular limitations, as the metal compound to be incorporated in the basic solution. Specifically, any of the water-soluble polyvalent metal salts described above, metal complex compounds, inorganic oligomers and inorganic polymers may be used. More specifically, zirconium compounds and the compounds listed as inorganic mordants in JP-A No. 2005-14593, paragraphs [0100] and [0101] may be used. Examples of the metal complex compounds include the metal complexes described in Kagaku Sosetsu (Review of Chemistry), No. 32 (1981), edited by The Chemical Society of Japan, and the transition metal complexes containing transition metals such as ruthenium as described in Coordination Chemistry Review, vol. 84, pages 85-277 (1988), and JP-A No. 2-182701.

Among them, a zirconium compound and a zinc compound are preferred, and a zirconium compound is particularly preferred. Examples of the zirconium compound include ammonium zirconium carbonate, ammonium zirconium nitrate, potassium zirconium carbonate, ammonium zirconium citrate, zirconyl stearate, zirconyl octylate, zirconyl nitrate, zirconium oxychloride and zirconium chloride hydroxide. In particular, ammonium zirconium carbonate is preferred. Further, the basic solution may include two or more metal compounds (preferably including a zirconium compound) in combination.

The content of the metal compound (particularly, a zirconium compound) in the basic solution is preferably from 0.05% by mass to 5% by mass, and more preferably from 0.1% by mass to 2% by mass, with respect to the total mass (including the solvent) of the basic solution. When the content of the metal compound (particularly a zirconium compound) is adjusted to be in the foregoing range, the coating layer may be sufficiently cured, reduction in function as a mordant, which may prevent provision of sufficient print density and beading, may be prevented, and impairment of a working environment due to an excessive increase in the concentration of the basic compound such as ammonia may be prevented. In an embodiment, two or more metal compounds may be used in combination. When a metal compound is used in combination with at least one mordant other than metal compounds among the mordant components described below, the mordant may be used in such an amount that the total content of the metal compound and the other mordants falls within the range specified above and that the effects of the invention are not impaired.

From the viewpoints of image density and ozone resistance, it is also preferable that the basic solution contains, as a metal compound, a magnesium salt such as those described above. The magnesium salt is particularly preferably magnesium chloride.

When the magnesium salt is contained, the amount of the magnesium salt contained in the basic solution is preferably from 0.1% by mass to 1% by mass, and more preferably from 0.15% by mass to 0.5% by mass, with respect to total mass of the basic solution.

The basic solution may contain the other crosslinking agents and one or more other mordant components, if necessary.

The basic solution may be prepared, for example, by adding a metal compound (such as a zirconium compound; in an amount of, for example, from 1% to 5%) and a basic compound (such as ammonium carbonate; in an amount of, for example, from 1% to 5%), and, optionally, paratoluenesulfonic acid (in an amount of, for example, from 0.5% to 3%), to ion exchange water, and then thoroughly stirring them. The “%” value for each ingredient represents % by mass of ingredient with respect to the total solid mass of the basic solution.

The solvent used for the preparation of the basic solution may be water, an organic solvent or a mixture thereof. Examples of organic solvents which may be used include alcohols such as methanol, ethanol, n-propanol, i-propanol and methoxypropanol; ketones such as acetone and methyl ethyl ketone; tetrahydrofuran; acetonitrile; ethyl acetate; and toluene.

Cooling Process, Drying Process

The method of producing the inkjet recording medium of the invention may include cooling the coating layer formed in the coating process and the optional basic solution applying process, so as to reduce the temperature of the coating layers to a temeperature that is at least 5° C. lower than the lower of the temperature of the first coating liquid during the coating and the temperature of the second coating liquid during the coating (hereinafter, referred to as “cooling process”); and drying the cooled coating layer to form an ink-receiving layer (hereinafter, referred to as “drying process”).

The cooling of the coating layer in the cooling process is preferably carried out by cooling the substrate on which the coating layer has been formed in a cooling zone maintained at a temperature of from 0° C. to 10° C. (preferably at a temperature of from 0° C. to 5° C.) for from 5 seconds to 30 seconds.

The temperature of the coating layer is determined by measuring the temperature of the layer surface.

Additional Process

In the present invention, the ink-receiving layer that has been formed on the substrate may be calendered by, for example, passing the substrate having the ink-receiving layer through a nip between rolls under heat and pressure using a super calender, a gloss calender, or the like, whereby surface smoothness, glossiness, transparency, and film strength can be improved. However, the calender treatment sometimes decreases porosity of the ink-receiving layer (which results in decrease in ink absorbency). Therefore, the calender treatment should be performed under conditions that cause less decrease in porosity of the ink-receiving layer.

The roll temperature in the calender treatment is preferably from 30° C. to 150° C., and more preferably from 40° C. to 100° C.

The linear pressure applied between the rollers in the calender treatment is preferably from 50 kg/cm to 400 kg/cm, and more preferably from 100 kg/cm to 200 kg/cm.

### EXAMPLES

Hereinafter, the invention is described in detail with reference to examples, but the invention is not limited to the following examples as long as the invention does not depart from the original gist thereof. Further, unless otherwise specified, “part(s)” and “%” are calculated on the basis of mass. Further, the “coating amount” with respect to each coating liquid represents not the coating amount of solid content but the coating amount of the coating liquid (wet coating amount) unless otherwise specified.

### Example 1

### Production of Inkjet Recording Medium

### Manufacture of Water-Impermeable Substrate

50 parts of LBKP obtained from acacia and 50 parts of LBKP obtained from aspen were respectively beaten to a Canadian Standard Freeness of 300 ml by a disk refiner so as to prepare a pulp slurry.

Next, to the pulp slurry obtained as described above, 1.3% of cationic starch (CAT0304L, manufactured by Nippon NSC), 0.15% of anionic polyacrylamide (POLYACRON ST-13, manufactured by Seiko Chemical Industries Co., Ltd.), 0.29% of alkylketene dimer (SIZEPINE K, manufactured by Arakawa Chemical Industries, Ltd.), 0.29% of epoxidized amide behenate and 0.32% of polyamide polyamine epichlorohydrin (ARAFIX 100, manufactured by Arakawa Chemical Industries, Ltd.) were added, and thereafter 0.12% of a defoamer was added thereto. The percentages above are percentages relative to the pulp.

The pulp slurry prepared as described above was used for paper making using a Gourdrinier paper machine. The felt face of the web was pressed against a drum dry cylinder with a dryer canvas interposed therebetween with the tensile strength of the dryer canvas set at 1.6 Kg/cm, thereby drying the web. Then, polyvinyl alcohol (KL-118, manufactured by Kuraray Co., Ltd.) was coated on both sides of a base paper in an amount of 1 g/m² by size press, and then dried and calendered. The base paper was formed to have a basis weight of 157 g/m², and thus a base paper having a thickness of 157 μm (substrate paper) was obtained.

The wire face side (rear face) of the obtained substrate paper was subjected to corona discharge treatment. Thereafter, polyethylene prepared by blending high-density polyethylene/low-density polyethylene at a ratio of of 80%/20% was coated on the wire face at a coating amount of 20 g/m² by melt extrusion at a temperature of 320° C. using a melt extruder, whereby a thermoplastic resin layer having a matte surface was formed (hereinafter, the surface having the thermoplastic resin layer is referred to as a “rear face,” and the other surface is referred to as a “front face”.) The thermoplastic resin layer on the rear face was subjected to a further corona discharge treatment, and thereafter, a dispersion liquid prepared by dispersing aluminum oxide (“ALUMNA ZOL 100,” manufactured by Nissan Chemical Industries, Ltd.) and silicon dioxide (“SNOWTEX O,” manufactured by Nissan Chemical Industries, Ltd.) at a mass ratio of 1:2 as antistatic agents in water was applied at a dry mass of 0.2 g/m². Subsequently, the front face (the other surface of the rear face) was subjected to a corona discharge treatment, and then, polyethylene having a density of 0.93 g/m³ which included 10% by mass of titanium oxide was coated thereon in an amount of 24 g/m² by melt extrusion at a temperature of 320° C. using a melt extruder, whereby a polyethylene resin-coated paper in which both sides of of the base paper were coated with polyethylene (water-impermeable substrate) was obtained.

Preparation of First Coating Liquid (for Lower Layer)

(1) Calcined kaolin, (2) ion exchange water, and (3) “SHALLOL DC-902P (trade name)” were mixed and dispersed, and then (4) boric acid, (5) polyvinyl alcohol solution, (6) “SUPERFLEX 650-5” described below were added to the obtained dispersion liquid at 30° C. to prepare a first coating liquid (for a lower layer).

The mass ratio of the calcined kaolin to the polyvinyl alcohol (PB ratio=calcined kaolin: polyvinyl alcohol) was 15.6:1. The first coating liquid (for the lower layer) had a pH of 4.5, and indicated acidity. Further, the surface tension of the first coating liquid (for the lower layer) was 35.5 mN/m.

Composition of first coating liquid (for the lower layer)

| | | |
|---|---|---|
| (1) calcined kaolin (KAOCAL (trade name), manufactured by SHIRAISHI CALCIUM | 8.9 | parts |
| KAISHA, LTD.) | | |
| (2) ion exchange water | 7.0 | parts |
| (3) “SHALLOL DC-902P (trade name)” (51.5% aqueous solution) | 0.78 | parts |
| (Dispersant, nitrogen-containing organic cationic polymer, manufactured by Dai-ichi Kogyo | | |
| Seiyaku Co., Ltd.) | | |
| (4) boric acid (7.5% aqueous solution) | 8.0 | parts |
| (5) polyvinyl alcohol (water-soluble resin) solution | 8.6 | parts |

Composition of polyvinyl alcohol solution

| | | |
|---|---|---|
| JM33 (trade name) (polyvinyl alcohol (PVA); saponification degree: 95.5%, polymerization | 0.574 | parts |
| degree: 3,300, manufactured by Japan Vam & Poval Co., Ltd.) | | |
| HPC-SSL (trade name) (water-soluble cellulose, manufactured by Nippon Soda Co., Ltd.) | 0.011 | parts |
| Ion exchange water | 7.890 | parts |
| Diethyleneglycol monobutyl ether (“BUTYCENOL 20P (trade name)” manufactured by | 0.065 | parts |
| Kyowa Hakko Kogyo Co., Ltd.; high boiling point organic solvent) | | |
| EMULGEN 109P (trade name, surfactant, manufactured by Kao Corporation) | 0.061 | parts |
| (6) cationically-modified polyurethane (SUPERFLEX 650-5 (25% aqueous solution), trade | 1.8 | parts |
| name, manufactured by Dai-ichi Kogyo Seiyaku Co., Ltd.) | | |

Preparation of Second Coating Liquid (for Upper Layer)

(1) Fumed silica fine-particles, (2) ion exchange water, (3) “SHALLOL DC-902P (trade name)”, and (4) “ZA-30 (trade name)” represented by the following composition were mixed and were dispersed using a liquid-liquid collision dispersing machine (ULTIMAIZER, trade name, manufactured by Sugino Corporation), and the obtained dispersion liquid was heated to 45° C. and maintained at this temperature for 20 hours. After that, (5) boric acid, (6) polyvinyl alcohol solution, and (7) cationically-modified polyurethane were added at 30° C. to the dispersion liquid to prepare a second coating liquid (for an upper layer).

The mass ratio of the silica fine particles to the water-soluble resin (PB ratio=silica fine particles: water-soluble resin) was 4.9:1. The second coating liquid (for the upper layer) had a pH of 3.4 and indicated acidity. Further, the surface tension of the second coating liquid (for the upper layer) was 35.4 mN/m.

Composition of second coating liquid (for upper layer)

| | | |
|---|---|---|
| (1) fumed silica fine particles (inorganic fine particles) | 8.9 | parts |
| (AEROSIL300SF75, trade name, manufactured by NIPPON AEROSIL CO., LTD) | | |
| (2) ion exchange water | 47.3 | parts |
| (3) “SHALLOL DC-902P (trade name)” (51.5% aqueous solution) | 0.78 | parts |
| (dispersant, nitrogen-containing organic cationic polymer, manufactured by Dai-ichi Kogyo | | |
| Seiyaku Co., Ltd.) | | |
| (4) “ZA-30” (trade name) | 0.48 | parts |
| (manufactured by Daichi Kigenso Kagaku Kogyo Co., Ltd., zirconyl acetate) | | |
| (5) boric acid (7.5% aqueous solution) | 4.38 | parts |
| (6) polyvinyl alcohol (water-soluble resin) solution | 26.0 | parts |

Composition of polyvinyl alcohol solution

| | | |
|---|---|---|
| JM33 (trade name) (polyvinyl alcohol (PVA); saponification degree: 95.5%, polymerization | 1.81 | parts |
| degree: 3,300, manufactured by Japan Vam & Poval Co., Ltd.) | | |
| HPC-SSl (trade name) (water-soluble cellulose, manufactured by Nippon Soda Co., Ltd.) | 0.08 | parts |
| Ion exchange water | 23.38 | parts |
| Diethyleneglycol monobutyl ether (“BUTYCENOL 20P (trade name)” manufactured by | 0.55 | parts |
| Kyowa Hakko Kogyo Co., Ltd.; high boiling point organic solvent) | | |
| EMULGEN 109P (trade name) (surfactant, manufactured by Kao Corporation) | 0.18 | parts |
| (7) cationically-modified polyurethane (SUPERFLEX 650-5, trade name, (25% aqueous | 1.8 | parts |
| solution), manufactured by Dai-ichi Kogyo Seiyaku Co., Ltd.) | | |

Formation of Ink-Receiving Layer

After corona discharge treatment was carried out on the front face of the obtained water-impermeable substrate, the first coating liquid (for the lower layer) and the second coating liquid (for the upper layer) were coated as described below on the front face with an extrusion die coater to form a coating layer by simultaneously multilayer-coating.

Specifically, in simultaneously multilayer-coating, the first coating liquid (for the lower layer) and the following in-line liquid were in-line blended, and the blended liquid was coated on the lower layer such that coating amount of the first coating liquid (for the lower layer) was 35 g/m² and the rate (coating amount) of the in-line liquid was 12 g/m². The second coating liquid (for the upper layer) and the following in-line liquid were in-line blended and coated on the upper layer such that coating amount of the second coating liquid (for the upper layer) was 85 g/m² and the rate (coating amount) of the in-line liquid was 12 g/m² (The layer configuration was as follows: the second coating liquid (for the upper layer)/the first coating liquid (for the lower layer)/substrate).

Composition of in-line liquid

| | |
|---|---|
| (1) ALPINE 83 (trade name) (Taimei Chemical Co., Ltd, 23% | 2.0 parts |
| aqueous solution) | |
| (2) ion exchange water | 7.8 parts |
| (3) HIMAX SC-507 (trade name) (diethyl amine epichloro- | 0.2 parts |
| hydrine polycondensation manufactured by HYMO Co., Ltd.) | |

The coating layer formed by the simultaneously multilayer-coating was dried by a hot-air drier at 80° C. (air speed: from 3 to 8 m/s) such that the concentration of the solid content of the coating layer was 36%. The coating layer showed constant rate drying during this period. Immediately after drying (while constant rate drying was shown), the coating layer was immersed in a basic solution having the following composition for 3 seconds and 10 g/m² of the basic solution was applied on the coating layer, followed by drying at 72° C. for 10 minutes (drying process) to form an ink-receiving layer on the water-impermeable substrate.

Composition of basic solution

| | |
|---|---|
| (1) boric acid | 0.65 parts |
| (2) ammonium carbonate (first grade: manufactured by | 5.0 parts |
| Kanto Chemical Co., Inc.) | |
| (3) ion exchange water | 88.35 parts |
| (4) polyoxyethylene lauryl ether (surfactant) | 6.0 parts |
| (Manufactured by Kao Corporation, “EMULGEN 109P | |
| (trade name)” (10% aqueous solution), HLB value: 13.6) | |

As described above, the inkjet recording medium (the total thickness of the ink-receiving layers was 26 μm) including the water-impermeable substrate, and the first ink-receiving layer having a thickness of 16 μm and the second ink-receiving layer having a thickness of 10 μm which were provided on the water-impermeable substrate in this order was obtained.

Subsequently, as the content ratio (% by mass) of boron in the total solid content of the first coating liquid (for the lower layer) and the in-line liquid which was added to the first coating liquid (for the lower layer), the content ratio of boron in the first ink-receiving layer (the lower layer) (content ratio 1;% by mass) was calculated.

Further, as the content ratio (% by mass) of boron in the total solid content of the second coating liquid (for the upper layer) and the in-line liquid which was added to the second coating liquid (for the upper layer), the content ratio of boron in the second ink-receiving layer (the upper layer) (content ratio 2;% by mass) was calculated.

Content ratio 1, content ratio 2, and the ratio (content ratio 2/content ratio 1) are shown in Table 1.

Measurement and Evaluation

The following measurements and evaluations were carried out for the obtained inkjet recording medium. The results of the measurements and evaluations are shown in the following Table 1.

Glossiness Difference Between Water-Impermeable Substrate and Recording Medium

First, 60° glossiness of a surface of the inkjet recording medium at a side at which the ink-receiving layer was provided (referred to as glossiness B))(unit:°)) was measured using a digital variable angle gloss meter (manufactured by Suga Test Instrument Co., Ltd.).

Subsequently, the inkjet recording medium which had been measured for glossiness as described above was immersed, for 1 minute, in sodium hypochlorite solution which had been heated to 80° C., and then the ink-receiving layer was removed using a sponge in flowing water.

After drying, 60° glossiness of a surface of the substrate at a side at which the ink-receiving layer had been removed (referred to as glossiness A (unit:°)) was measured using a digital variable angle gloss meter (manufactured by Suga Test Instrument Co., Ltd.).

The obtained glossiness A and glossiness B were used, and the glossiness difference) (°) was calculated according to the following equation (a).

Glossiness difference (°)=glossiness A) (°)−glossiness B (°) equation (a)

Fingerprint Mark

The surface of the ink-receiving layer of the obtained inkjet recording medium was pressed with a finger. The fingerprint mark (fingerprint) was observed visually and the fingerprint mark was evaluated according to the following evaluation criteria.

Evaluation criteria
A: Fingerprint marking was not observed at all.
B: Fingerprint marking was slightly observed at a practically tolerable level.
C: Fingerprint marking was observed at a practically intolerable level.
D: Fingerprint marking was observed distinctly.

Ink Absorbency

A solid image of each of Y(yellow), M(magenta), C(cyan), K(black), R(red), G(green), and B(blue) colors was printed using an inkjet printer PM-D600 (trade name, manufactured by Seiko Epson Corporation; set to EPSON photo paper mode;).

The obtained solid images were observed visually, and ink absorbency was evaluated according to the following evaluation criteria.

### Evaluation Criteria

A: Unabsorbed ink remaining on the inkjet recording medium was not observed for any color.
B: Unabsorbed ink remaining on the inkjet recording medium was observed for less than two colors, which is a practically tolerable level.
C: Unabsorbed ink remaining on the inkjet recording medium was observed for from two colors to less than three colors, which is a practically intolerable level.
D: Unabsorbed ink remaining on the inkjet recording medium was observed for three or more colors, which is a practically absolutely intolerable level.

Surface Condition

The surface of the ink-receiving layer of the obtained inkjet recording medium was observed while irradiating light from an oblique direction, and the surface condition was evaluated according to the following evaluation criteria.

### Evaluation Criteria

A: No streaks were seen using a magnifying lens with 20 times magnification, and the surface condition was very favorable.
B: Streaks were not seen visually, but a slight streak having a wavelike pattern was seen using a magnifying lens with 20 times magnification.
C: Streaks having a wavelike pattern were seen visually.

### Example 2

An inkjet recording medium was produced in the same manner as in Example 1 except that the KAOCAL (trade name) in the first coating liquid was changed to the same amount of KAOBRITE 90 (trade name, manufactured by SHIRAISHI CALCIUM KAISHA, LTD.; kaolin clay), and evaluation was carried out in the same manner as in Example 1. Evaluation results are shown in Table 1.

### Example 3

An inkjet recording medium was produced in the same manner as in Example 1 except that in the composition of the first coating liquid (for the lower layer), 8.0 parts of (4) boric acid were changed to 5.5 parts of (4) boric acid, and 7.0 parts of (2) ion exchange water were changed to 9.5 parts of (2) ion exchange water. Evaluation was carried out in the same manner as in Example 1. Evaluation results are shown in Table 1.

### Comparative Example 1

An inkjet recording medium was produced in the same manner as in Example 1 except that the first coating liquid (for the lower layer) did not contain boric acid, the second coating liquid (for the upper layer) did not contain boric acid and the basic solution did not contain boric acid. Evaluation was carried out in the same manner as in Example 1. Evaluation results are shown in Table 1.

### Comparative Example 2

An inkjet recording medium was produced in the same manner as in Example 1 except that the amount of boric acid in the first coating liquid (for the lower layer) was reduced such that the ratio (content ratio 2/content ratio 1) was changed to 1.00. Evaluation was carried out in the same manner as in Example 1. Evaluation results are shown in Table 1.

### Comparative Example 3

An inkjet recording medium was produced in the same manner as in Comparative Example 2 except that the KAOCAL (trade name) in the first coating liquid (for lower layer) was changed to the same amount of wet-process silica (SUNOWTEX O, trade name, manufactured by Nissan Chemical Industries, Ltd., primary particle diameter: 10 to 20 nm). Evaluation was carried out in the same manner as Example 1. Evaluation results are shown in Table 1.

TABLE 1

| | | | | | Comparative | Comparative | Comparative |
|---|---|---|---|---|---|---|---|
| | | Example 1 | Example 2 | Example 3 | Example 1 | Example 2 | Example 3 |
| Second ink-receiving | Pigment | Fumed silica | Fumed silica | Fumed silica | Fumed silica | Fumed silica | Fumed silica |
| layer (upper layer) | Content ratio of boron | 0.51 | 0.51 | 0.51 | 0.00 | 0.51 | 0.51 |
| | (content raio 2; % | | | | | | |
| | by mass) | | | | | | |
| First ink-receiving | Pigment | KAOCAL | KAOBRITE 90 | KAOCAL | KAOCAL | KAOCAL | Wet-process |
| layer (lower layer) | | (trade name) | (trade name) | (trade name) | (trade name) | (trade name) | silica |
| | Classification of pigment | Calcined kaolin | Kaolin clay | Calcined kaolin | Calcined kaolin | Calcined kaolin | — |
| | Content ratio of boron | 0.90 | 0.90 | 0.63 | 0.00 | 0.51 | 0.51 |
| | (content ratio 1; % | | | | | | |
| | by mass) | | | | | | |

| | | | | | | |
|---|---|---|---|---|---|---|
| Content ratio (content ratio 2:cotent ratio 1) | 0.57 | 0.57 | 0.81 | — | 1.00 | 1.00 |
| Surface condition | A | A | B | C | C | A |
| Glossiness of substrate at 60° | 52% | 52% | 52% | 52% | 52% | 52% |
| (glossiness A) | | | | | | |
| Glossiness of recording medium at 60° | 13% | 14% | 15% | 9% | 10% | 33% |
| (glossiness B) | | | | | | |
| Glossiness difference | 39% | 38% | 37% | 43% | 42% | 19% |
| (glossiness A − glossiness B) | | | | | | |
| Fingerprint mark (fingerprint) | A | A | A | A | A | C |
| Ink absorbency | A | B | A | A | A | A |

As shown in Table 1, the occurrence of fingerprint marks was suppressed and surface conditions were excellent in Examples 1 to 3 in which the content ratio of boron in the first ink-receiving layer (the lower layer) was higher than the content ratio of boron in the second ink-receiving layer (the upper layer).

In contrast, Comparative Example 1 in which the first ink-receiving layer (the lower layer) and the second ink-receiving layer (the upper layer) did not contain boron and Comparative Example 2 in which the content ratio of boron in the first ink-receiving layer (lower layer) was equal to the content ratio of boron in the second ink-receiving layer (the upper layer) were inferior in surface condition to Examples 1 to 3.

Further, fingerprint marks were a larger problem in Comparative Example 3 in which the fumed silica was used in the first ink-receiving layer (the lower layer) as a pigment.

According to the invention, there can be provided an inkjet recording medium in which occurence of fingerprint trace when the surface was pressed with finger was suppressed and surface condition was excellent and the method of producing the same.

Embodiments of the present invention include, but are not limited to, the following.

<1> An inkjet recording medium comprising: a water-impermeable substrate, and a first ink-receiving layer containing kaolin and a second ink-receiving layer containing fumed silica, which are provided on the water-impermeable substrate in this order from a water-impermeable substrate side,

wherein at least the first ink-receiving layer further contains a boron compound, and a content ratio (% by mass) of boron in a total solid content of the first ink-receiving layer is higher than a content ratio (% by mass) of boron in a total solid content of the second ink-receiving layer.

<2> The inkjet recording medium according to <1>, wherein the second ink-receiving layer further contains a boron compound, and when the content ratio (% by mass) of boron in the total solid content of the first ink-receiving layer is defined as content ratio 1and the content ratio (% by mass) of boron in the total solid content of the second ink-receiving layer is defined as content ratio 2, the ratio (content ratio 2/content ratio 1) is from 0.10 to 0.90.

<3> The inkjet recording medium according to <1>or <2>, wherein a glossiness at an angle of 60° of a surface of the inkjet recording medium at a side at which the first and second ink-receiving layers are provided is at least 30% lower than a glossiness at an angle of 60° of the water-impermeable substrate.

<4> The inkjet recording medium according to any one of <1>to <3>, wherein the kaolin comprises calcined kaolin.

<5> The inkjet recording medium according to any one of <1>to <4>, wherein the water-impermeable substrate comprises a polyolefin resin-coated paper.

<6> A method of manufacturing an inkjet recording medium, the method comprising:

forming ink-receiving layers by simultaneously multilayer-coating, onto a water-impermeable substrate, at least a first coating liquid containing kaolin and a second coating liquid containing fumed silica in this order from a water-impermeable substrate side,

wherein at least the first coating liquid further contains a boron compound, and a content ratio (% by mass) of boron in a total solid content of the first coating liquid is higher than a content ratio (% by mass) of boron in a total solid content of the second coating liquid.

<7> The method of manufacturing the inkjet recording medium according to <6>, wherein the second coating liquid further contains a boron compound, and when the content ratio (% by mass) of boron in the total solid content of the first coating liquid is defined as content ratio 1a and the content ratio (% by mass) of boron in the total solid content of the second coating liquid is defined as content ratio 2a, the ratio (content ratio 2a/content ratio 1a) is from 0.10 to 0.90.

<8> The method of manufacturing the inkjet recording medium according to <6> or <7>, the method further comprising applying a basic solution containing a basic compound to the ink-receiving layers either (1) at the same time as the forming of the ink-receiving layers by coating the first coating liquid and the second coating liquid, or (2) during drying of the ink-receiving layers formed by coating the first coating liquid and the second coating liquid but before the ink-receiving layers exhibit falling-rate drying.

<9> The method of manufacturing the inkjet recording medium according to <8>, wherein the basic solution further contains a boron compound, and when the content ratio (% by mass) of boron in the total solid content of the first coating liquid is defined as content ratio 1a and the content ratio (% by mass) of boron in the total solid content of the second coating liquid and the basic solution is defined as content ratio 3a, the ratio (content ratio 3a/content ratio 1a) is from 0.10 to 0.90.

<10> The method of manufacturing the inkjet recording medium according to any one of <6>to <9>, wherein a glossiness at an angle of 60° of a surface of the inkjet recording medium at a side at which the ink-receiving layers are provided is at least 30% lower than a glossiness at an angle of 60° of the water-impermeable substrate.

<11> The method of manufacturing the inkjet recording medium according to any one of <6>to <10>, wherein the kaolin comprises calcined kaolin.

<12> The method of manufacturing the inkjet recording medium according to any one of <6>to <11>, wherein the water-impermeable substrate comprises a polyolefin-resin coated paper.

All publications, patent applications, and technical standards mentioned in this specification are herein incorporated by reference to the same extent as if each individual publication, patent application, or technical standard was specifically and individually indicated to be incorporated by reference.

What is claimed is:

1. An inkjet recording medium comprising: a water-impermeable substrate, and a first ink-receiving layer containing kaolin and a second ink-receiving layer containing fumed silica which are provided on the water-impermeable substrate in this order from a water-impermeable substrate side,
wherein at least the first ink-receiving layer further contains a boron compound, and a content ratio (% by mass) of boron in a total solid content of the first ink-receiving layer is higher than a content ratio (% by mass) of boron in a total solid content of the second ink-receiving layer.

2. The inkjet recording medium according to claim 1, wherein the second ink-receiving layer further contains a boron compound, and when the content ratio (% by mass) of boron in the total solid content of the first ink-receiving layer is defined as content ratio 1 and the content ratio (% by mass) of boron in the total solid content of the second ink-receiving layer is defined as content ratio 2, the ratio (content ratio 2/content ratio 1) is from 0.10 to 0.90. glossiness of a surface of the inkjet recording medium at a side at which the ink-receiving layer is provided

3. The inkjet recording medium according to claim 1, wherein a glossiness at an angle of 60° of a surface of the inkjet recording medium at a side at which the first and second ink-receiving layers are provided is at least 30% lower than a glossiness at an angle of 60° of the water-impermeable substrate.

4. The inkjet recording medium according to claim 1, wherein the kaolin comprises calcined kaolin.

5. The inkjet recording medium according to claim 1, wherein the water-impermeable substrate comprises a polyolefin resin-coated paper.

6. A method of manufacturing an inkjet recording medium, the method comprising:
forming ink-receiving layers by simultaneously multilayer-coating, onto a water-impermeable substrate, at least a first coating liquid containing kaolin and a second coating liquid containing fumed silica in this order from a water-impermeable substrate side,
wherein at least the first coating liquid further contains a boron compound, and a content ratio (% by mass) of boron in a total solid content of the first coating liquid is higher than a content ratio (% by mass) of boron in a total solid content of the second coating liquid.

7. The method of manufacturing the inkjet recording medium according to claim 6, wherein the second coating liquid further contains a boron compound, and when the content ratio (% by mass) of boron in the total solid content of the first coating liquid is defined as content ratio 1a and the content ratio (% by mass) of boron in the total solid content of the second coating liquid is defined as content ratio 2a, the ratio (content ratio 2a/content ratio 1a) is from 0.10 to 0.90.

8. The method of manufacturing the inkjet recording medium according to claim 6, the method further comprising applying a basic solution containing a basic compound to the ink-receiving layers either (1) at the same time as the forming of the ink-receiving layers by coating the first coating liquid and the second coating liquid, or (2) during drying of the ink-receiving layers formed by coating the first coating liquid and the second coating liquid but before the ink-receiving layers exhibit falling-rate drying.

9. The method of manufacturing the inkjet recording medium according to claim 8, wherein the basic solution further contains a boron compound, and when the content ratio (% by mass) of boron in the total solid content of the first coating liquid is defined as content ratio 1a and the content ratio (% by mass) of boron in the total solid content of the second coating liquid and the basic solution is defined as content ratio 3a, the ratio (content ratio 3a/content ratio 1a) is from 0.10 to 0.90.

10. The method of manufacturing the inkjet recording medium according to claim 6, wherein a glossiness at an angle of 60° of a surface of the inkjet recording medium at a side at which the ink-receiving layers are provided is at least 30% lower than a glossiness at an angle of 60° of the water-impermeable substrate.

11. The method of manufacturing the inkjet recording medium according to claim 6, wherein the kaolin comprises calcined kaolin.

12. The method of manufacturing the inkjet recording medium according to claim 6, wherein the water-impermeable substrate comprises a polyolefin-resin coated paper.
